(19) United States
(12) Patent Application Publication
(10) Pub. No.: US 2015/0113704 A1
(43) Pub. Date: Apr. 30, 2015

(54) HYDROPHILIC/HYDROPHOBIC AQUEOUS POLYMER EMULSIONS AND PRODUCTS AND METHODS RELATING THERETO

(71) Applicant: ALLEGIANCE CORPORATION, Waukegan, IL (US)

(72) Inventors: Wei Cheong WONG, Kulim (MY); SHIPING WANG, Libertyville, IL (US); Chii Yih LOW, Bayan Lepas (MY); Chuang Sim CHONG, Penang (MY); Xiaochuan HU, State College, PA (US); Dennis KOPP, Glendale, CA (US); Andre MAYER, Bois Le Roi (FR); Michael MEYERS, Lock Haven, PA (US); Daniel L. Holguin, Fullerton, CA (US); Sou Phong LEE, Arcadia, CA (US)

(73) Assignee: ALLEGIANCE CORPORATION, Waukegan, IL (US)

(21) Appl. No.: 14/527,584

(22) Filed: Oct. 29, 2014

Related U.S. Application Data
(60) Provisional application No. 61/896,906, filed on Oct. 29, 2013.

(51) Int. Cl. C09D 133/08; C09D 133/14; A41D 19/04; C09D 129/04; A41D 19/00; C09D 133/16; C08K 5/41

(52) U.S. Cl. CPC C09D 133/08; C09D 133/16; C09D 133/14; C08K 5/41; C09D 129/04; A41D 19/0055; A41D 19/04
USPC 2/167; 524/558; 524/544; 524/555; 524/156; 524/503; 2/169

(57) ABSTRACT

Methods for preparing copolymeric emulsions from at least one water soluble monomer and at least one water insoluble monomer are disclosed herein. In some embodiments, one or more surfactants and stabilizers may be used. In some embodiments, the monomers used in the process include, by total monomer weight, at least 50% water soluble monomers and at least 10% water insoluble monomers. Copolymer emulsions formed from the reaction product of at least one water soluble monomer and at least one water insoluble monomer are also disclosed along with articles coated with such emulsions and coating formulations made from such emulsions as well as methods for the manufacture and coating of such articles.

### CROSS-REFERENCE TO RELATED APPLICATION

This application claims the benefit of U.S. provisional application No. 61/896,906, entitled “Hydrophilic/Hydrophobic Aqueous Polymer Emulsions and Products and Methods Relating Thereto”, having a filing date of Oct. 29, 2013, and is hereby incorporated by reference in its entirety.

### FIELD

A coating formulation made from a copolymer emulsion used to coat articles and a method for the manufacture and coating of such articles.

### BACKGROUND

Medical articles, such as gloves and other elastomeric articles, often come in contact with liquids and fluids during their use. Such articles form a barrier between the user's skin and the external environment. Medical gloves, such as examination gloves and surgical gloves, are examples of articles used in the healthcare setting, and they play a key role in minimizing the spread of infectious diseases. Such articles are used frequently by health care professionals. Therefore, it is important for medical articles such as gloves to provide an effective barrier, while providing an adequate level of comfort to the user. Coated articles in particular are ideally smooth and non-tacky, and they preferably have a coating that does not flake off. There is a need in the art for such articles, and methods of making such articles.

Coatings have been used in products, such as for enhancing the desirable features of rubber gloves. Previous coatings have been developed, such as those disclosed in U.S. Pat. Nos. 4,548,844; 4,575,476; 6,242,042; 6,706,313; 7,179,415; 6,772,443; 7,032,251; 6,706,836; 6,743,880; 7,019,067; 6,653,427; 6,828,399; 6,284,856; and 5,993,923, each of which is incorporated in its entirety as if set forth fully herein. All references cited herein are incorporated by reference in their entirety.

### SUMMARY

A novel and useful preparation of a copolymer emulsion is provided. In one embodiment, a method for forming a copolymer emulsion is provided by combining and copolymerizing at least one water soluble monomer and at least one water insoluble monomer, wherein the monomers used in the process are comprised of at least 50% by weight water soluble monomer and at least 10% by weight water insoluble monomer as measured by the total monomer weight.

In another embodiment, the method for the preparation of a copolymer emulsion is provided that includes concurrently combining a monomer feed and a pre-emulsion feed to form an emulsion, wherein the monomer feed comprises at least 50% by weight water soluble monomer based on the total monomer weight of the monomer feed and the pre-emulsion feed, and the pre-emulsion feed comprises at least 10% by weight water insoluble monomer based on the total monomer weight of the monomer feed and the pre-emulsion feed.

In still another embodiment, the method for the preparation of a copolymer emulsion is provided by concurrently combining a monomer feed and a pre-emulsion feed to form a monomer mixture, wherein the monomer feed comprises at least 50% by weight water soluble monomer and wherein the pre-emulsion feed comprises at least 10% water insoluble monomer, with such percentages based on the total monomer weight of the monomer feed and the pre-emulsion feed. The method further requires introducing into a reactor and agitating an initial charge that includes a stabilizer, a surfactant, an initiator, and deionized water and maintaining the reactor contents at about 55° C. and at a pH above about 6.0. The method also includes introducing about 6% of the monomer feed and about 6% of the pre-emulsion feed into the reactor and maintaining the temperature and pH for about ten minutes, followed by introducing an activator feed into the reactor. The activator feed, which includes deionized water and sodium hydroxymethanesulfinate, is introduced at a rate such that the contents of the activator feed will be exhausted concurrently with or after the exhaustion of the monomer feed and the pre-emulsion feed. The remaining monomer feed and pre-emulsion feed are introduced into the reactor at a constant rate to fully feed the remaining contents over a span of about 4.5 hours. Then, after the monomer feed, pre-emulsion feed, and activator feed have been fully introduced into the reactor, a post feed, including a second initiator, is introduced into the reactor and the temperature and pH is maintained for about one hour to complete polymerization.

In still another embodiment, articles are provided comprising a coating comprising at least one water soluble monomer and at least one water-insoluble monomer, and methods of making the same. Methods of making such articles are also provided.

The accompanying drawings, which are incorporated in and constitute a part of this specification, illustrate one or more embodiments and, together with the description, serve to explain the principles of the copolymer emulsion and related processes of making and of using.

### BRIEF DESCRIPTION OF THE DRAWINGS

A full and enabling disclosure, including the best mode thereof directed to one of ordinary skill in the art, is set forth in the specification, which makes reference to the appended drawings, in which:

FIG. 1A is a scanning electron microscope image, at 500 times magnification, of a surgical glove coated with a comparative water-soluble coating without a crosslinker;

FIG. 1B is a scanning electron microscope image of the glove in FIG. 1A at 1000 times magnification;

FIG. 2A is a scanning electron microscope image, at 500 times magnification, of a second surgical glove coated with a comparative water-soluble coating and applied with a crosslinker;

FIG. 2B is a scanning electron microscope image of the glove in FIG. 2A at 1000 times magnification.

FIG. 3A is a scanning electron microscope image, at 500 times magnification, of a surgical glove coated with one embodiment of an emulsion coating as disclosed herein and applied with a crosslinker;

FIG. 3B is a scanning electron microscope image of the glove in FIG. 3A at 1000 times magnification;

FIG. 4A is a scanning electron microscope image, at 200 times magnification, of a surgical glove coated with a comparative solvent-based coating and applied with a crosslinker;

FIG. 4B is a scanning electron microscope image of the glove in FIG. 3A at 1000 times magnification.

FIG. 5 is a scanning electron microscope image, at 1000 times magnification, of a second surgical glove coated with a comparative solvent-based coating and applied with a crosslinker;

FIG. 6 is a scanning electron microscope image, at 1000 times magnification, of a second surgical glove coated with a second embodiment of an emulsion coating as disclosed herein and applied with a crosslinker; and

FIG. 7 is a scanning electron microscope image, at 1000 times magnification, of a third surgical glove coated with an emulsion coating as disclosed herein and applied with a crosslinker.

FIG. 8A is a scanning electron microscope image, at 1000 times magnification, of the patient-side (i.e., the exterior side of the glove when worn) of a fourth surgical glove coated with another embodiment of an emulsion coating as disclosed herein and applied with a crosslinker and without acid priming.

FIG. 8B is a scanning electron microscope image, at 1000 times magnification, of the patient-side of a fifth surgical glove coated with another embodiment of an emulsion coating as disclosed herein and applied with a crosslinker and with acid priming.

FIG. 9A is a graph of contact angle data glove for the glove of FIG. 8A.

FIG. 9B is a graph of contact angle data glove for the glove of FIG. 8B.

FIG. 10A is a scanning electron microscope image, at 1000 times magnification, of the donning-side (i.e., the side that would contact a user's skin when worn) of the glove of FIG. 8B with high chorine and using a glove turning process.

FIG. 10B a scanning electron microscope image, at 1000 times magnification, of the donning-side of the glove of FIG. 8A with high chorine and using a glove turning process.

FIG. 11A is a graph of contact angle data glove for the glove of FIG. 10A.

FIG. 11B is a graph of contact angle data glove for the glove of FIG. 10B.

FIG. 12A is a scanning electron microscope image, at 1000 times magnification, of the patient-side of a sixth glove coated with another embodiment of an emulsion coating as disclosed herein and applied with a crosslinker and without acid priming.

FIG. 12B is a scanning electron microscope image, at 1000 times magnification, of the patient-side of a seventh glove coated with an emulsion coating as disclosed herein and applied with a crosslinker and with acid priming.

FIG. 12C is a scanning electron microscope image, at 1000 times magnification, of the donning-side of the glove of FIG. 12A coated without acid priming.

FIG. 13A is a scanning electron microscope image, at 1000 times magnification, of the patient-side of an eighth glove coated with an emulsion coating as disclosed herein and applied with a crosslinker and without acid priming.

FIG. 13B is a scanning electron microscope image, at 1000 times magnification, of the patient-side of a glove of FIG. 13A coated with an emulsion coating as disclosed herein and applied with a crosslinker and without acid priming.

FIG. 14 is a scanning electron microscope image, at 1000 times magnification, of the patient-side of a glove coated with a comparative solvent-based coating and applied with a crosslinker and without acid priming.

FIG. 15A is a scanning electron microscope image of a patient-side of a film coated with an emulsion coating as disclosed herein and applied with a crosslinker.

FIG. 15B is a scanning electron microscope image of a patient-side of a film coated with an emulsion coating as disclosed herein and applied with a crosslinker.

FIG. 15C is a scanning electron microscope image of a patient-side of a film coated with a comparative solvent-based coating and applied without a crosslinker.

Repeat use of reference characters in the present specification and drawings is intended to represent same or analogous features or elements.

### DETAILED DESCRIPTION

Reference will now be made in detail to presently preferred embodiments, one or more examples of which are illustrated in the accompanying drawings. Each example is provided by way of explanation of the copolymer emulsion and methods of making and using, not limitation thereof. In fact, it will be apparent to those skilled in the art that modifications and variations can be made without departing from the scope or spirit thereof. For instance, features illustrated or described as part of one embodiment may be used on another embodiment to yield a still further embodiment. Thus, it is intended that the disclosure herein covers such modifications and variations as come within the scope of the appended claims and their equivalents.

The polymer emulsions provided herein are acrylic emulsion copolymers that are the reaction product of a mixture of monomers. As used herein, the term “monomer” is meant in a broad sense to encompass monomers and oligomers as would be used in building a desired copolymer. The polymer emulsions are prepared by copolymerizing at least one hydrophilic water soluble monomer together with at least one hydrophobic water insoluble monomer. As used herein, monomer percentages are based on the weight percent of the total (soluble and insoluble) monomer weights.

The emulsions may be prepared by copolymerizing a water soluble monomer mixture, which is referenced as the “monomer feed,” and a water insoluble monomer mixture, which is referenced as the “pre-emulsion feed.” As described in detail herein, these feeds may be combined, optionally with other components such as surfactants and stabilizers, to create a polymeric emulsion.

The monomer feed used to form an emulsion may include 2-hydroxyethyl methacrylate, 4-hydroxybutyl acrylate, 2-hydroxybutyl acrylate, or mixtures thereof. These particular monomers are water soluble monomers that form water insoluble polymers. 2-hydroxyethyl methacrylate may be obtained from Mitsubishi Rayon, of Tokyo, Japan, and, in some embodiments, the 2-hydroxyethyl methacrylate may have a purity of about 97% or greater. In some embodiments, an emulsion may be prepared by copolymerizing monomers that include at least about 40% water soluble monomers. In other embodiments, an emulsion may be prepared by copolymerizing monomers that include at least about 50% water soluble monomers. In some embodiments, about 50% to about 90% water soluble monomers may be used, including each intermittent value therein, including 75%. In some embodiments, about 60% to about 80% water soluble monomer may be used, and in other embodiments about 72% to about 80% water soluble monomer may be used. In still further embodiments, about 30% to about 90% water soluble monomer may be used. Specific exemplary embodiments are provided in the examples below. The monomer feed may also include deionized water.

In still further embodiments, the monomer feed may include other water soluble monomers, including, without limitation, quaternary amine(meth)acrylate monomers, other hydroxy-alkyl(meth)acrylate monomers, N-vinyl lactam monomers, ethylenically unsaturated carboxylic acid monomers, and mixtures thereof. In some embodiments, additional water soluble monomers that result in water soluble polymers may be added to the monomer feed to impart flexibility, polarity, crosslinking, solubility, adhesion, or other desired properties. In some embodiments, such water soluble monomers may include 2-hydroxyethyl acrylate, hydroxypropyl acrylate, hydroxypropyl methacrylate (which has limited water solubility), acrylic acid, methacrylic acid, itaconic acid, N-vinyl pyrrolidone, N-vinyl caprolactam, 1-vinyl-2-piperidone, 1-vinyl-5-methyl-2-pyrrolidone, acrylamide, methacrylamide, N-isobutoxymethyl acrylamide. Ethoxylated (meth)acrylate monomers with an average of 10 ethylene oxide units, such as ethoxylated hydroxyethylmethacrylate, are available from Nippon Nyukazai Co., Ltd. of Chuo-ku, Tokyo under the product designation MA-100A. Quaternary amine(meth)acrylates, such as dimethylaminoethyl acrylate methyl chloride quaternary, are available from CPS Chemical Co. of Old Bridge, N.J. under the product designation Agelfex FA1Q80MC. By way of example, these other monomers may be present in the monomer feed in some embodiments up to about 25% by weight of the water soluble monomers in the monomer feed. In some other embodiments, these other monomers may be present in amounts up to about 25% by weight of the entire emulsion (including the monomer feed and pre-emulsion feed).

A pre-emulsion feed may include at least one water insoluble monomer. By way of example, and without limitation, the water insoluble monomers that may used in the pre-emulsion feed include methyl acrylate, ethyl acrylate, butyl acrylate, propyl acrylate, 2-ethylhexyl acrylate, butyl methacrylate, methyl methacrylate, lauryl methacrylate, stearyl methacrylate, 2-ethylhexyl methacrylate, trifluoroethyl methacrylate, isooctyl acrylate, isodecyl acrylate, isobornyl acrylate, dimethylaminoethyl methacrylate, styrene, vinyl esters (such as vinyl acetate, vinyl butyrate, vinyl propionate, vinyl isobutyrate, vinyl valerate, and vinyl versitate), diesters of dicarboxylic acid (such as di-2-ethylhexyl maleate, di-octyl maleate, di-ethylhexyl fumarate, di-ethyl fumarate, and di-butyl fumarate), isobornyl acrylate, cyclohexyl acrylate, and similar monomers. By way of example, one water insoluble monomer that may be used in embodiments, namely 2-methacryloylxyethyl phthalic acid, is available from Mitsubishi Rayon Co., Ltd. under the product designation Acryester PA. In some embodiments, an emulsion may be prepared by copolymerizing monomers that include at least about 10% to about 50% water insoluble monomers. In other embodiments, an emulsion may be prepared by copolymerizing monomers that include at least about 10% to about 60% or about 70% water insoluble monomers.

In addition, the pre-emulsion feed may include more than one water insoluble monomer, such as mixtures of the foregoing insoluble monomers. For example, in one embodiment, both 2-ethylhexyl acrylate and methyl methacrylate may be included in the pre-emulsion feed at about 11% each. In other embodiments, these amounts may be varied.

In some embodiments, the pre-emulsion feed may also include methacrylic acid as a monomer, wherein methacrylic acid is a water soluble monomer. In some embodiments, water soluble monomers may be added to the pre-emulsion feed, such as 2-hydroxyethyl acrylate, hydroxypropyl acrylate, hydroxypropyl methacrylate (limited water solubility), acrylic acid, methacrylic acid, itaconic acid, N-vinyl pyrrolidone, N-vinyl caprolactam, 1-vinyl-2-Piperidone, 1-vinyl-5-methyl-2-pyrrolidone, acrylamide, Methacrylamide, N-isobutoxymethyl acrylamide. As indicated above, ethoxylated (meth)acrylate with an average of 10 ethylene oxide units, such as ethoxylated hydroxyethylmethacrylate, may be obtained from Nippon Nyukazai Co., Ltd. of Chuo-ku, Tokyo under the product designation MA-100A. In addition, quaternary amine(meth)acrylates, such as dimethylaminoethyl acrylate methyl chloride quaternary, are available from CPS Chemical Co. of Old Bridge, N.J. under the product designation Agelfex FA1Q80MC.

Although the amount of methacrylic acid, or other water soluble monomers, may vary for each emulsion and each application, exemplary amounts (as based on the weight percent of the total (soluble and insoluble) monomer weights) may include about 0% to about 25%, including each interval therein, and in other embodiments the amount may be about 0% to about 15%, including each interval therein. In some embodiments, this amount may be about 0% to about 10% or about 1% to about 10%, including each interval therein. In other embodiments, this amount may be about 10% of the total monomer weight. In yet other embodiments, this amount may be about 1 to 5%, including each intermittent value therein.

The pre-emulsion feed may also include an internal crosslinker, which may increase the gel content of the resulting polymer. In some embodiments, the internal crosslinker may include at least one multifunctional acrylate monomer. Such multifunctional acrylate monomer may include, by way of example, polyethylene glycol diacrylate, hexanediol diacrylate, trimethylolpropane triacrylate, pentaerythritol triacrylate, and propylene glycol diacrylate. The internal crosslinker may be added at about 0.1 to about 1.0 parts by weight of the pre-emulsion feed.

By way of example, emulsions may be prepared by combining a monomer feed and a pre-emulsion feed in a reactor. In some embodiments, sequential polymerization may be employed in which the first monomer mixture may be added to a reactor and at least partially reacted and then the second monomer mixture is slowly introduced and reacted. In some embodiments, sequential polymerization may result in a polymer having a core made of the first monomer feed and a shell made of subsequent monomer feeds. Examples and further disclosure of sequential polymerization may be found in U.S. Pat. No. 6,706,836 (including examples 26 and 27), U.S. Pat. No. 6,465,591, and U.S. Pat. No. 6,828,399 and U.S. Published Patent Application No. 2003/0144446, each of which is incorporated in its entirety as if set forth fully herein.

In other embodiments, concurrent feeds may be used in which a first monomer mixture and a second monomer mixture are concurrently introduced into a reactor and reacted. In some embodiments employing a concurrent feed, a portion of a first monomer mixture and a portion of a second monomer mixture may be initially provided in the reactor. However, when such starting material is identical to the monomer feeds that are subsequently and concurrently introduced into the reactor, then the resulting polymeric emulsion is not believed to have a core and shell but instead has a consistent formulation. The examples provided herein provide parameters that may be used in certain embodiments using concurrent feeds. Although the foregoing processes have been described using only two monomer mixtures, one of ordinary skill in the art would readily appreciate that additional mixtures and feeds may be used in some embodiments.

An initiator, such as a dissociative initiator, a redox initiator, or an oil soluble initiator may also be added during the process. By way of example, such initiators may include, but are not limited to, persulfates such as ammonium persulfate, potassium persulfate and sodium persulfate, hydrogen peroxide, tert-butyl hydroperoxide, and azo compounds such as 4,4′-azobis(4-cyanovaleric acid). Redox initiators include, but are not limited to, persulfates with bisulfate, such as sodium persulfate with sodium metabisulfite, hydrogen peroxide with ferrous ion, sulfite ion, bisulfite ion or ascorbic acid, and hydroperoxides with sulfoxylates, such as tert-butyl hydroperoxide with sodium formaldehyde sulfoxylate. By way of example, such oil soluble initiators may include, but are not limited to, 2,2′-azobis(isobutyronitrile), 2,2′-azobis(2-methylbutyronitrile), benzoyl peroxide, and lauryl peroxide. Based on the disclosure herein, other initiators are known to those of skill in the art that would be suitable for use herein.

In preparing a polymeric emulsion, a surfactant may also be utilized in the method disclosed herein. In some embodiments, the surfactant may be sodium lauryl ether sulfate, such as Disponil FES 77 (32%) available from Cognis (a part of the BASF Group), of Cincinnati, Ohio. The surfactant may be included in an initial charge mixture as indicated in the examples herein. In some embodiments, surfactant may be added in an amount of from about 0.5% to about 5% as based on the dry weight of surfactant to weight of the monomers. In other embodiments, surfactant may be added in an amount of about 0.1% to about 10% based on the dry weight of surfactant to the weight of the monomers. In still other embodiments, this surfactant amount may be about 0.2% to about 5%, and in other embodiments the surfactant amount may be about 0.5% to about 2%. Based upon the disclosure herein, other surfactants are known to those of skill in the art that would be suitable for use herein.

By way of further example, and without limitation, other anionic surfactants that may be suitable for use in embodiments disclosed herein include sodium dioctyl sulfosuccinate, lauryl sulfates, octyl sulfates, 2-ethylhexyl sulfates, lauramine oxide, decyl sulfates, tridecyl sulfates, cocoates, lauroyl sarcosinates, lauryl sulfosuccinates, linear C₁₀ diphenyl oxide disulfonates, lauryl sulfosuccinates, lauryl ether sulfates (1 and 2 moles ethylene oxide), mystristyl sulfates, oleates, stearates, tallates, ricinoleates, cetyl sulfates.

In some embodiments, nonionic surfactants may be used along with anionic surfactants. By way of example, and without limitation, nonionic surfactants that may be used in embodiments disclosed herein include, methyl gluceth-10, PEG-20 methyl glucose distearate, PEG-20 methyl glucose sesquistearate, C₁₁₋₁₅ pareth-20, ceteth-12, dodoxynol-12, laureth-15, PEG-20 castor oil, polysorbate 20, steareth-20, polyoxyethylene-10 cetyl ether, polyoxyethyl-ene-10 stearyl ether, polyoxyethylene-20 cetyl ether, polyoxyethylene-10 oleyl ether, polyoxyethylene-20 oleyl ether, ethoxylated nonylphenol, ethoxylated octylphenol, ethoxylated dodecylphenol, or ethoxylated fatty (C₆-C₂₂) alcohol, including 3 to 20 ethylene oxide moieties, polyoxyethylene-20 isohexadecyl ether, polyoxyethylene-23 glycerol laurate, polyoxy-ethylene-20 glyceryl stearate, PPG-10 methyl glucose ether, PPG-20 methyl glucose ether, polyoxyethylene-20 sorbitan monoesters, polyoxyethylene-80 castor oil, polyoxyethylene-15 tridecyl ether, polyoxyethylene-6 tridecyl ether, laureth-2, laureth-3, laureth-4, PEG-3 castor oil, PEG 600 dioleate, PEG 400 dioleate, oxyethanol, 2,6,8-trimethyl-4-nonyloxypolyethylene, oxyethanol: octylphenoxy polyethoxy ethanol, nonylphenoxy polyethoxy ethanol, and 2,6,8-trimethyl-4-nonyloxypolyethylene alkyleneoxypolyethyeneoxyethanol.

In addition, a stabilizer may also be used in the process to form an emulsion. In some embodiments, a suitable stabilizer includes polyvinyl alcohol, such as BP-04 (15%) grade from Chang Chun Pertochemical Co., Ltd. of Taipei, Taiwan or Mowiol 4-88 from Kuraray America, Inc. of Houston, Tex. In some embodiments, Elvanol 51-03 from Dupont Chemical of Wilmington, Del. and/or Selvol 203 from Sekisui Specialty Chemical Co., Ltd. of Osaka, Japan may be used stabilizers. The stabilizer may be included in an initial charge mixture and/or a pre-emulsion mixture. In some embodiments, a stabilizer may be added in an amount from about 1% to about 10% as based on the dry weight of stabilizer to the weight of the monomers. Based upon the disclosure herein, other stabilizers are known to those of skill in the art that would be suitable for use herein.

Finally, a crosslinker may be optionally used in preparing emulsions. In some embodiments, a crosslinker may be added to the copolymer in an amount of from about 0 to about 15%, including each intermittent value therein, as based on the dry weight of crosslinker to the dry weight of the copolymer. In some embodiments, a crosslinker may be added in an amount of from about 0 to about 10% based upon the dry weight of the copolymer. In other embodiments, the about 1, 2, 3, 4, 5, 6, 7, 8, 9, or 10% based on the dry weight of the copolymer. Suitable crosslinkers include, but are not limited to, formaldehydes, melamine formaldehydes, metal salts, aziridines, isocyanates, dichromates, and similar crosslinkers. Additional crosslinkers may include polyfunctional aziridine, polyamide-epichlorohydrin-type resin, or carbodiimide compounds. Exemplary metal salts that may be used as crosslinkers in some embodiments include, without limitation, zirconium ammonium carbonate, zinc ammonium carbonate, aluminum acetate, calcium acetate, chromium acetate, zinc acetate, zirconium acetate. In other embodiments, no crosslinker is used in preparing an emulsion. Unless otherwise noted herein, percentages used to reference crosslinkers indicate dry weight of crosslinker to the dry weight of the copolymer. In some embodiments, the crosslinker comprises melamine formaldehyde or mixtures comprising melamine formaldehyde. In some embodiments, the crosslinker may be present in a percent weight amount of preferably about 1% to about 10%, more preferably 2% to 5%, and most preferably 3% to 4%.

As indicated above, the emulsions may be prepared by copolymerizing the water soluble monomer or monomers in the monomer feed and the water insoluble monomer or monomers in the pre-emulsion feed. In one exemplary embodiment, the preparation process may be conducted by also introducing an initial charge (also referenced as a “reactor charge”), a catalyst feed, an activator feed, and a post add feed into the reactor during the manufacturing process.

An exemplary process for preparing emulsions may commence by introducing an initial charge into a reactor. In some embodiments, the initial charge may include deionized water and one or more surfactants. The surfactants may be selected to improve the miscibility of the monomers or groups of monomers that will be copolymerized. In some embodiments, sodium lauryl ether sulfate may be used as a surfactant in the initial charge.

The initial charge may also include a stabilizer, such as polyvinyl alcohol, a surfactant, such as sodium lauryl ether sulfate, an initiator, such as tertiary-butyl hydroperoxide, an activator, such as sodium hydroxymethanesulfinate (available under the name Bruggolite E01 from Bruggemann Chemical of Newton Square, Pa.), and an oxygen scavenger, such as sodium iron ethylenediaminetetraacetate (“NaFe EDTA”) (available from Supreme Resources, Inc. of Suwanee, Ga.). This initial charge may be added to a reactor and agitation may be initiated at an appropriate rate, such as at 80 revolutions per minute, to begin the preparation process. The reactor contents may also be heated to a temperature in the range of about 50° C. to about 60° C. In some embodiments, the reactor contents may be heated in the range of about 53° C. to about 55° C. In other embodiments, the reactor contents may be heated to about 55° C.

After the contents of the reactor are heated to the desired temperature, a portion of the monomer feed and a portion of the pre-emulsion feed may be added to the reactor. In some embodiments, the ratio of monomer feed to the pre-emulsion feed added to the reactor at this stage may be between about 2.5:1 and about 3.5:1, and in some embodiments the ratio may be about 3:1. In addition, an initial amount of feed may be added that is approximately 5-7% of the weight percentage of each of the monomer feed and the pre-emulsion feed.

Following the addition of these initial monomer mixtures to the reactor, the addition of the activator feed to the reactor may be initiated. The activator feed may include sodium hydroxylmethanesulfinate, such as Bruggolite E01 available from Bruggemann Chemical of Newton Square, Pa. In some embodiments, the activator feed may be supplied at a constant rate such that the contents will be exhausted contemporaneously with, or after, the subsequently-initiated monomer and pre-emulsion feeds become exhausted. In some embodiments, the activator feed may be exhausted within about thirty minutes of the monomer feed and pre-emulsion feed being exhausted, such as twenty minutes thereafter.

After initiating the activator feed, agitation of the reactor contents may be continued without additional content being added for a short period, such as ten minutes. Then, after a suitable lapse, the monomer feed and the pre-emulsion feed may be fed into the reactor. These feeds may be added at respective addition rates such that their contents are completely added to the reactor at the end of a predetermined time. For instance, in some embodiments, the contents of these feeds may be constantly added over the course of about 4.5 hours. As indicated above, the activator feed is also fed at a rate to deplete at the same time as the monomer and pre-emulsion feeds are depleted.

After the contents of the monomer feed and the pre-emulsion feed have been entirely added to the reactor, the reactor may be maintained at the desired temperature discussed above. The reactor environment may be maintained for approximately 30 minutes, and then a post add feed may be added to the reactor. The post add feed may include an initiator, such as tertiary-butyl hydroperoxide or a biocide, such as Acticide GA, available from Thor Specialties, Inc. of Trumbull, Conn. (which is an aqueous blend of chlorinated and non-chlorinated isothiazolinones and 2-bromo-2-nitro-1,3-propanediol). After the post add feed has been introduced, the reaction environment may be maintained for approximately one hour.

By way of example and without intending to limit the scope, an example of one emulsion may be formed using the components set forth in Table 1 by performing the following steps, which in some embodiments may be performed in the recited order:
1. add the initial charge to the reactor and set agitation to 80 RPM;
2. heat and maintain the reactor contents at 55° C.;
3. prepare the monomer, catalyst and activator feeds;
4. add the following contents to the reactor when the existing reactor contents reach 55° C.:
   Monomer Feed: 13.7 lbs
   Pre-Emulsion Feed: 4.7 lbs;
5. start the activator feed (t=0);
6. after 10 minutes (t=10), begin introducing the pre-emulsion, monomer, and catalyst feeds over 270 minutes;
7. maintain the reactor contents at 55° C.;
8. after the pre-emulsion supply is exhausted from the feed, flush the tank and lines with rinse deionized water;
9. after the activator feed has been completely added (˜t=300); maintain the environment with agitation for 30 minutes; and
10. after the aforementioned 30-minute period (˜t=330), add post add feed and maintain the reactor contents at about 55° C. for 1 hour (until ˜t=390).

TABLE 1

| Batch Size | | | 600 lbs |
|---|---|---|---|
| | Parts | % total | Batch |
| Initial Charge | | | |
| BP-04 (15%) polyvinyl alcohol | 8.12 | 0.0203 | 12.2 |
| Disponil FES 77 (32%) | 0.08 | 0.0002 | 0.12 |
| NaFe EDTA | 0.01 | 0.0000 | 0.01 |
| t-Butyl Hydroperoxide | 0.10 | 0.0002 | 0.14 |
| DI Water | 56.16 | 0.1402 | 84.1 |
| Reactor Charge Total | 64.46 | | 96.55 |
| Monomer Feed | | | |
| DI Water | 140.09 | 0.3497 | 209.8 |
| 2-Hydroxyethyl Methacrylate | 75.00 | 0.1872 | 112.3 |
| Feed Total | 215.09 | | 322.2 |
| Pre Emulsion (Initial Tank) | | | |
| DI Water | 7.92 | 0.0198 | 11.9 |
| Disponil FES 77 (32%) | 3.56 | 0.0089 | 5.3 |
| Polyvinyl alcohol (BP-04 (15%)) | 8.12 | 0.0203 | 12.2 |
| 2-Ethylhexyl Acrylate | 11.00 | 0.0275 | 16.5 |
| Methyl Methacrylate | 11.00 | 0.0275 | 16.5 |
| Methacrylic Acid | 3.00 | 0.0075 | 4.5 |
| Ammonium Hydroxide (19%) | 2.25 | 0.0056 | 3.37 |
| Pre-Emulsion Total | 46.84 | | 70.2 |
| Catalyst Feed | | | |
| DI Water | 16.28 | 0.0406 | 24.4 |
| t-Butyl Hydroperoxide | 0.38 | 0.0009 | 0.57 |
| Catalyst Total | 16.66 | | 25.0 |
| Activator Feed | | | |
| DI Water | 14.05 | 0.0351 | 21.0 |
| Bruggolite E01 | 0.28 | 0.0007 | 0.42 |
| Activator Total | 14.32 | | 21.5 |
| Post Add Feed | | | |
| t-Butyl Hydroperoxide | 0.20 | 0.0005 | 0.30 |
| Biocide (Acticide GA) | 0.11 | 0.0003 | 0.17 |
| DI Water | 1.98 | 0.0049 | 2.97 |
| Rinse Water | | | |
| DI Water | 4.21 | 0.0105 | 6.3 |
| Dilution | | | |
| DI Water | 36.69 | 0.0916 | 55.0 |
| Total | 400.56 | 1.000 | 600.0 |

Based on the foregoing procedures using the components in Table 1, the feed rate information may be summarized as follows:

| | Rate 1 | Rate 2 |
|---|---|---|
| Monomer | | |
| Weight (lbs) | 13.7 | 308.5 |
| Time (min) | | 270 |
| Rate (lbs/min) | | 1.14 |
| Pre Emulsion | | |
| Weight (lbs) | 4.7 | 65.5 |
| Time (min) | | 270 |
| Rate (lbs/min) | | 0.24 |
| Catalyst | | |
| Weight (lbs) | 25.0 | |
| Time (min) | 270 | |
| Rate (lbs/min) | 0.09 | |
| Activator | | |
| Weight (lbs) | 21.5 | |
| Time (min) | 300 | |
| Rate (lbs/min) | 0.07 | |

By way of a second example, an emulsion was also prepared by performing the following steps using the components set forth in Table 2 below:
1. adding reactor charge to the reactor; agitating and heating the reactor contents to 53-55° C. with a 55° C. bath;
2. adding 35.2 g monomer feed and 11.1 g pre-emulsion feed to the reactor;
3. initiating the activator feed at a rate to exhaust in 300 minutes, i.e., at 0.17 g/min (51.0 g);
4. maintaining the system for 10 minutes and then initiating the monomer feed and the pre-emulsion feed to exhaust in 270 mins, i.e., at 1.90 g/min (512.8 g) and 0.57 g/min (154.7 g), respectively;
5. maintaining the reaction environment in the system for 30 minutes;
6. adding the post add feed after the contents of the activator feed have been completely added; and
7. maintaining the reaction environment for about 1 hour and then cooling.

TABLE 2

| | Wt |
|---|---|
| | (grams) |
| Reactor Charge | |
| Mowiol 4-88 (15%) | 28.9 |
| Disponyl FES 77 (32%) | 0.28 |
| NaFe EDTA | 0.02 |
| TBHP 70 | 0.28 |
| DI Water | 197.3 |
| Reactor Charge Total | 226.8 |
| #1 Monomer Feed | |
| DI Water | 279.6 |
| 2-Hydroxyethyl Methacrylate | 267.0 |
| TBHP 70 | 1.41 |
| Monomer Feed Total | 548.0 |
| #2 Pre-Emulsion Feed | |
| DI Water | 28.2 |
| Disponyl FES 77 (32%) | 12.7 |
| Mowiol 4/88 (15%) | 28.9 |
| NH₃ (30%) | 7.0 |
| 2-Ethyhexyl Acrylate | 78.3 |
| Methacrylic Acid | 10.7 |
| Emulsion Feed Total | 165.8 |
| #3 Activator Feed | |
| DI Water | 50.0 |
| Buggolite E01 | 0.99 |
| Activator Feed Total | 51.0 |
| Post Add Feed | |
| TBHP 70 | 0.71 |
| Acticide GA | 0.40 |
| DI Water | 7.05 |
| Dilution | |
| DI Water | 425.00 |
| Total | 1424.8 |

As evidenced by the foregoing description and examples, aqueous emulsions prepared with total monomer amounts including over 50% water soluble monomers and at least 10% water insoluble monomers may be provided. In some embodiments, water soluble monomers may account for between about 50% and about 90% of the total monomers used in the process, including each intermittent value therein. In other embodiments, water soluble monomers may account for about 75% of the total monomer content. In addition, the emulsion may be formed using about 10% or more water insoluble monomers. In some embodiments, one or more water soluble monomers may account for about 10% to about 50%, including each intermittent value therein, of the total monomers used in the process. In some embodiments, multiple different soluble and/or insoluble monomers may be used as part of the monomer contents. In embodiments in which the emulsions are used as coatings, the water soluble monomer(s) may impart a hydrogel nature to the coating, which may provide desirable donning characteristics, and the water insoluble monomer(s) may provide other desirable properties and performances characteristics to the coating. Therefore, the water soluble and water insoluble monomer proportions may be varied to result in the desired characteristics for a particular application.

Testing was performed on samples of water-soluble copolymer coatings, solvent-based copolymer coatings, and copolymer emulsion coatings, wherein the polymer emulsions were prepared in accordance with the procedures disclosed herein. The samples were prepared using the indicated monomer ratios. The emulsion samples were prepared using the procedures set forth above for the Table 2 components except as modified by the components for each sample as identified below.

TABLE 3

| Sample Reference | Polymer Base | HEMA/EHA/MAA |
|---|---|---|
| 1 | Water | 60/30(HBA)/10 |
| 2 | Water | 60/30(HBA)/10 |
| 3 | Water | 90/0/10 |
| 4 | Water | 90/0/10 |
| 5 | Water | 97/0/3 |
| 6 | | |
| (90% Sample 3 − | Water | 87/3(HBA)/10 |
| 10% Sample 2) | | |
| 7 | | |
| (90% Sample 3 − | Water | 87/3(HBA)/10 |
| 10% Sample 2) | | |
| 8 | Solvent | 68/23/9 |
| 9 | Solvent | 93/5/2 |
| 10 | Solvent | 95/5/0 |
| 11 | Solvent | 75/25/0 |
| 12 | Emulsion | 75/22/3 |
| 13 | Emulsion | 75/22/3 |
| 14 | Emulsion | 75/22/3 |
| 15 | Emulsion | 75/22(EHMA)/3 |
| 16 | Emulsion | 75/22(EHMA)/3 |
| 17 | Emulsion | 75/22(LM)/3 |
| 18 | Emulsion | 75/22(LM)/3, with Silica |
| 19 | Emulsion | (HEMA/EHA/MMA/MAA: |
| | | 75/11/11/3) |
| 20 | Emulsion | (HEMA/EHA/MMA/MAA: |
| | | 75/14/8/3) |
| 21 | Emulsion | (HEMA/EHA/MMA/MAA: |
| | | 75/17/6/3) |
| 22 | Emulsion | (HEMA/EHA/MMA/MAA: |
| | | 75/19/3/3) |
| 23 | Emulsion | (HEMA/EHA/MMA/MAA: |
| | | 75:11.8:11.8:1.5) |
| 24 | Emulsion | (HEMA/EHA/MMA/MAA: |
| | | 75/10.3/10.3/4.5) |
| 25 | Emulsion | (HEMA/EHA/MMA/MAA: |
| | | 75/9.5/9.5/6.0) |

As used above and herein, the term HEMA references 2-hydroxyethyl methacrylate, EHA references 2-ethylhexyl acrylate, HBA represents 4-hydroxybutyl acrylate, MAA references methacrylic acid, EHMA references 2-ethylhexyl methacrylate, LM references lauryl methacrylate, and MMA references methyl methacrylate. In addition, the crosslinkers referenced above are 2% XC113 (available from Shanghai Zealchen Co. Ltd. of Shanghai, China) which is a polyfunctional aziridine, 0.5% Tyzor AA (available form DuPont of Wilmington, Del.), which is titanium acetylacetonate, 2% Polycup 172 (available from Ashland of Columbus, Ohio), which is a water soluble, polyamide-epichlorohydrin-type resin, and 2% Carbodilite E-02 (available from Nissinbo Chemical Inc. of Chiba, Japan), which is a carbodimide compound. The amount of crosslinker is based on dry weight of crosslinker to dry weight of copolymer.

The comparative samples evaluated were prepared in accordance with the following general procedures and using the approximate parameters indicated below:

TABLE 4
Samples 1 and 2

| | grams |
|---|---|
| Reactor Charge | |
| Deionized water | 485.0 |
| Initial Initiator | |
| Denonized Water | 15.0 |
| Sodium Persulfate | 3.0 |
| (1.0% BOM) | |
| Monomer Feed | |
| 2-Hydroxymethyl | 180.0 |
| methacrylate | |
| 4-Hydroxybutyl acrylate | 90.0 |
| Methacrylic acid | 30.0 |
| Deionized water | 285.0 |
| Ammonium hydroxide | 14.0 |
| Cook-off #1 | |
| Deionized water | 50.0 |
| Sodium Persulfate | 0.30 |
| Cook-off #2 | |
| Deionized water | 50.0 |
| Sodium Metabisulfite | 0.30 |
| Total | 1202.6 |

Procedures
1. Add Reactor Charge and heat to about 74-75° C.
with a N₂ purge. Wait approximately 15 to 30
minutes.
2. Add Initial Initiator to heated Reactor Charge.
3. After ten minutes, start Monomer Feed at
3.33 g/min (3 hours).
4. After Monomer Feed, wait thirty minutes and
then start Cook-off #1 at 0.84 g/min (1 hour).
5. After about thirty minutes after Cook-off #1
added, start Cook-off #2 at 0.84 g/min (1 hour).
6. Add dilution water as needed.
7. After Cook-off #2 completely added, wait
about thirty minutes and then dilute to 4% and
start cooling and discharge.

TABLE 5
Samples 3 and 4

| | grams |
|---|---|
| Reactor Charge | |
| Deionized water | 727.5 |
| Initial Initiator | |
| Denonized Water | 22.5 |
| Sodium Persulfate | 2.25 |
| (0.5% BOM) | |
| Monomer Feed | |
| 2-Hydroxymethyl | 405 |
| methacrylate | |
| Methacrylic acid | 45.0 |
| Deionized water | 477.5 |
| Ammonium hydroxide | 21.0 |
| Cook-off #1 | |
| Deionized water | 50.0 |
| Sodium Persulfate | 0.5 |
| Cook-off #2 | |
| Deionized water | 50.0 |
| Sodium Metabisulfite | 0.5 |
| Total | 1801.7 |

Procedures
1. Add Reactor Charge and heat to 74-75° C. with a
N₂ purge. Wait approximately 15 to 30 minutes.
2. Add Initial Initiator to heated Reactor Charge.
3. After ten minutes, start Monomer Feed at 5.27
g/min (3 hours).
4. After Monomer Feed, wait thirty minutes and
then add Cook-off #1.
5. After one hour, add Cook-off #2.
6. After one hour, dilute to 4% and start cooling
and discharge.

TABLE 6
Sample 5

| | grams |
|---|---|
| Reactor Charge | |
| Deionized Water | 565.0 |
| Initial Initiator | |
| Denonized Water | 15.0 |
| Sodium Persulfate | 3.0 |
| Monomer Feed | |
| 2-HEMA (San Esters) | 291.0 |
| Methacrylic acid | 9.0 |
| Deionized water | 283.0 |
| Ammonium hydroxide | 12.0 |
| (19%) | |
| Cook-off #1 | |
| Deionized Water | 10.00 |
| Sodium Persulfate | 0.30 |
| Cook-off #2 | |
| Deionized Water | 10.00 |
| Sodium Metabisulfite | .30 |
| Acticide GA | 1.40 |
| Total | 1200.0 |

Procedures
1. Add Reactor Charge and heat to 74-75° C. with a
N₂ purge. Wait approximately 15 to 30 minutes.
2. Add Initial Initiator to heated reactor.
3. Wait ten minutes after Initial Initiator added
and then start Monomer Feed at 3.29 g/min
(592 g) (3 hrs.) and turn N₂ off.
4. After monomer feed added, wait one hour and
then add Cook-off #1.
5. After Cook-off #1 added, wait one hour and
then add cook-off #2.
6. One hour after Cook-off #2 added, dilute to 4%,
and start cooling and discharge.

TABLE 7
Sample 8

| | grams |
|---|---|
| Monomer Mix | |
| 2-Hydroxyethyl | 204.0 |
| Methacrylate (San Esters) | |
| 2-Ethylhexyl Acrylate | 69.0 |
| Methacrylic Acid | 27.0 |
| Ethanol | 204.0 |
| Ethyl Acetate | 69.0 |
| Methanol | 27.0 |
| Reactor Charge | |
| Monomer Mix | 150.0 |
| Initial Initiator | |
| Vazo 64 (0.1% BOM) | 0.08 |
| Ethanol | 10.00 |
| Monomer Feed | |
| Monomer Mix | 450.0 |
| Vazo 64 (0.1% BOM) | 0.23 |
| Solvent Feed | |
| Ethanol | 204 |
| Ethyl Acetate | 69 |
| Cook-off Feed | |
| Vazo 64 | 1.0 |
| Ethanol | 40.00 |
| Final Dilution | |
| Isopropyl Alcohol | 75.70 |
| Total | 1000.0 |

Procedures
1. Add Reactor Charge and heat to 74-75° C. with a
N₂ purge. (For sample 8, the reaction temperature
fluctuated from about 70° C. to about 76° C. but was
primarily maintained within the indicated 74-75° C.
range.) Wait approximately 15 to 30 minutes.
2. Add Initial Initiator to heated Reactor Charge.
Remove N₂ after the addition.
3. After “kick off,” wait ten minutes and start
Monomer Feed at 3.33 g/min (599 g) (3 hours).
For Sample 8, Monomer Feed was started about
thirty minutes after adding Initial Initiator.
4. Start Solvent Feed as needed: (2 hr) = 2.28
g/min (273 g). For Sample 8, Solvent Feed was
started about 2.5 hours after Monomer Feed
started and continued for about 45 minutes, and
then restarted after about 15 minutes.
5. After Monomer Feed, wait about 15-30 minutes
and then start Cook-off Feed at 0.34 g/min (41 g).
Wait one hour, then dilute to 4% and start cooling
and discharge.
As used herein, “kick off” indicates when reaction
or polymerization begins and is noted with an
increase in reaction temperature or bubbles in the
reactor as the reaction begins to boil or increase in
viscosity and trap air.
Note:
Vazo 64 is 2,2′-Azobis(2-methylpropionitrile), available from DuPont of Wilmington, Delaware.

TABLE 8
Sample 9

| | grams |
|---|---|
| Monomer Mix | |
| 2-Hydroxyethyl | 279.0 |
| Methacrylate (San Esters) | |
| 2-Ethylhexyl Acrylate | 15.0 |
| Methacrylic Acid | 6.0 |
| Methanol | 231.0 |
| Ethyl Acetate | 69.0 |
| Reactor Charge | |
| Monomer Mix | 150.0 |
| Initial Initiator | |
| Vazo 64 (0.1% BOM) | 0.08 |
| Ethyl Acetate | 10.0 |
| Monomer Feed | |
| Monomer Mix | 450.0 |
| Vazo 64 (0.1% BOM) | 0.23 |
| Solvent Feed | |
| Ethanol | 204 |
| Ethyl Acetate | 69 |
| Cook-off Feed | |
| Vazo 64 | 1.0 |
| Ethyl Acetate | 20.0 |
| Ethanol | 20.0 |
| Final Dilution | |
| Isopropyl Alcohol | 75.70 |
| Ethanol | 200.0 |
| Total | 1200 |

Procedures
1. Add Reactor Charge and heat to 74-75° C., with
a N₂ purge. Wait approximately 15 to 30 minutes
2. Add Initial Initiator to heated Reactor Charge.
3. After kick-off bubbling noticed, wait ten
minutes and start Monomer Feed at 2.50 g/min
(450.2 g) (3 hours). For Sample 9, Monomer Feed
started at about thirty minutes after Initial
Initiator added.
4. Start Solvent Feed as needed at 2.28 g/min
(273 g) (2 hr). For Sample 9, Solvent Feed started
at about 2.5 hours after Monomer Feed started
and run for about 1.5 hours and then restarted
after about 1.5 hours to add the remainder of
Solvent Feed after Cook-off started.
5. After Monomer Feed, wait 30 minutes (for
Sample 9 the wait was about one hour) and then
start Cook-off Feed at 0.34 g/min (41 g) (2 hours).
Wait one hour (about 30 minutes for Sample 9)
after the Cook-Off Feed added, then dilute to 4%
and start cooling and discharge.

TABLE 9
Sample 10

| | grams |
|---|---|
| Monomer Mix | |
| 2-Hydroxyethyl | 285.0 |
| Methacrylate | |
| 2-Ethylhexyl Acrylate EHA | 15.0 |
| Methanol | 240.0 |
| Ethanol | 270.0 |
| Ethyl Acetate | 140.0 |
| Reactor Charge | |
| Monomer Mix (75 g | 240.0 |
| monomer) | |
| Initial Initiator | |
| Vazo 64 (0.1% BOM) | 0.08 |
| Ethyl Acetate | 10.00 |
| Monomer Feed | |
| Monomer Mix | 710.0 |
| Vazo 64 (0.1% BOM) | 0.22 |
| Cook-off Feed | |
| Vazo 64 | 1.0 |
| Ethyl Acetate | 20.0 |
| Ethanol | 20.0 |
| Total | 1001.3 |

Procedures
1. Add Reactor Charge and heat to 68-70° C., with a N₂ purge. Wait
approximately 15 to 30 minutes.
2. Add Initial Initiator to heated Reactor Charge.
3. After Kick-off, wait ten minutes and then start Monomer Feed (w/N₂) at
3.96 g/min (713.2 g) ( 3hours).
4. After Monomer Feed added, wait 30 minutes and then start Cook-off
Feed at 0.34 g/min (41 g) (2 hours).
5. Hold 1 Hour after Cook-off Feed added, then dilute to 4% and start
cooling and discharge.

TABLE 10
Sample 11

| | grams |
|---|---|
| Monomer Mix | |
| 2-Hydroxyethyl | 225.0 |
| Methacrylate | |
| 2 Ethylhexyl Acrylate | 75.0 |
| Methanol | 240.0 |
| Ethanol | 270.0 |
| Ethyl Acetate | 140.0 |
| Reactor Charge | |
| Monomer Mix (75 g | 240.0 |
| monomer) | |
| Initial Initiator | |
| Vazo 64 (0.1% BOM) | 0.08 |
| Ethyl Acetate | 10.00 |
| Monomer Feed | |
| Monomer Mix | 710.0 |
| Vazo 64 (0.1% BOM) | 0.22 |
| Cook-off Feed | |
| Vazo 64 | 1.0 |
| Ethyl Acetate | 20.0 |
| Ethanol | 20.0 |
| Total | 1001.3 |

Procedures
1. Add Reactor Charge and heat to 68-70° C., with a N₂ purge. Wait
approximately 15 to 30 minutes.
2. Add Initial Initiator to heated Reactor Charge.
3. After Kick-off, wait 10 minutes and then start Monomer Feed (w/N₂) at
3.96 g/min (713.2 g) (3 hours).
4. After Monomer Feed added, wait 30 minutes and then start Cook-off
Feed at 0.34 g/min (41 g) (2 hours).
5. Dilute to 4% and start cooling and discharge.

TABLE 11
Samples 12, 13, and 14

| | grams |
|---|---|
| Reactor Charge | |
| Mowiol 4/88 (15%) | 28.9 |
| Disponyl FES 77(32%) | 0.28 |
| NaFe EDTA | 0.02 |
| TBHP 70 | 0.28 |
| Deionized Water | 197.3 |
| Monomer Feed | |
| Deionized Water | 279.6 |
| HEMA | 267.0 |
| TBHP 70 | 1.41 |
| Pre-Emulsion | |
| DI Water | 28.2 |
| Disponyl FES 77 (32%) | 12.7 |
| Mowiol 4/88 (15%) | 28.9 |
| NH₃ (30%) | 7.0 |
| Ethyhexyl Acrylate | 78.3 |
| Methacrylic Acid | 10.7 |
| Activator Feed | |
| Deionized Water | 50.0 |
| Buggolite E01 | 0.99 |
| Post Add | |
| TBHP 70 | 0.71 |
| Acticide GA | 2 |
| | drops |
| Deionized Water | 7.05 |
| Deionized Water | 425 |
| Total | 1425 |

Procedures
1. Add Reactor Charge and heat to 53-55° C., with a 55° C. bath. Wait
approximately 15 to 30 minutes.
2. Add 35.2 g Monomer Feed and 11.1 g Pre-Emulsion. Wait approximately
15 to 30 minutes.
3. Start Activator Feed. At 0.17 g/min (51.0 g) (300 min).
4. After fifteen minutes, start Monomer Feed and Pre-Emulsion. Monomer
Feed at 1.90 g/min (512.89 g) (270 minutes) and Pre-Emulsion at 0.57
g/min (154.7 g) (270 minutes).
5. Wait 30 minutes after Activation Feed added, and then add Post Add.
Then, dilute to 4% and start cooling and discharge.

TABLE 12
Samples 15 and 16

| | grams |
|---|---|
| Reactor Charge | |
| Mowiol 4/88 (15%) | 28.9 |
| Disponyl FES 77(32%) | 0.28 |
| NaFe EDTA | 0.02 |
| TBHP 70 | 0.28 |
| Deionized Water | 197.3 |
| Monomer Feed | |
| Deionized Water | 559.2 |
| 2-Hydroxyethyl | 267.0 |
| Methacrylate | |
| TBHP 70 | 1.4 |
| Pre-Emulsion | |
| Deionized Water | 28.2 |
| Disponyl FES 77 (32%) | 12.7 |
| Mowiol 4/88 (15%) | 28.9 |
| NH₃ (19%) | 7.0 |
| 2-Ethylhexyl methacrylate | 78.3 |
| Methacrylic Acid | 10.7 |
| Activator Feed | |
| Deionized Water | 50.0 |
| Buggolite E01 | 1.0 |
| Post Add | |
| TBHP 70 | 0.71 |
| Acticide GA | 0.40 |
| DI Water | 7.05 |
| Dilution | |
| Deionized Water | 135.6 |
| Total | 1425.0 |

Procedures
1. Add Reactor Charge and heat to 53-55° C., with a 55° C. bath. Wait
approximately 15 to 30 minutes.
2. Add 35.2 g Monomer Feed and 11.1 g Pre-Emulsion.
3. Start Activator Feed at 0.17 g/min (51.0 g) (300 min).
4. After 10 minutes, start Monomer Feed and Pre-Emulsion. Monomer Feed
at 2.93 g/min (792.4 g) (270 min) and Pre-Emulsion at 0.57 g/min (154.7 g)
(270 min). After Monomer Feed and Pre-Emulsion added, add 10 g of
deionized water from Dilution.
5. Wait 30 minutes after Activation Feed added, then add Post Add. Wait one
hour after Post Add added, then dilute to 4% and start cooling and discharge.

TABLE 13
Samples 17 and 18

| | grams |
|---|---|
| Reactor Charge | |
| Mowiol 4/88 (15%) | 28.9 |
| Disponyl FES 77(32%) | 0.28 |
| NaFe EDTA | 0.02 |
| TBHP 70 | 0.28 |
| Deionized Water | 197.3 |
| Monomer Feed | |
| Deionized Water | 559.2 |
| 2-Hydroxyethyl | 267.0 |
| Methacrylate | |
| TBHP 70 | 1.41 |
| Pre-Emulsion | |
| Deionized Water | 28.2 |
| Disponyl FES 77 (32%) | 12.7 |
| Mowiol 4/88 (15%) | 28.9 |
| NH₃ (19%) | 7.0 |
| Lauryl Methacrylate (LM) | 78.3 |
| Methacrylic Acid | 10.7 |
| Activator Feed | |
| Deionized Water | 50.0 |
| Buggolite E01 | 0.99 |
| Post Add | |
| TBHP 70 | 0.71 |
| Acticide GA | 0.40 |
| DI Water | 7.05 |
| Dilution | |
| Deionized Water | 135.6 |
| Total | 1425.0 |

Procedures
1. Add Reactor Charge and heat to 53-55° C., with a 55° C. bath. Wait
approximately 15 to 30 minutes.
2. Add 35.2 g Monomer Feed and 11.1 g Pre-Emulsion.
3. Start Activator Feed at 0.17 g/min (51.0 g) (300 min).
4. After 10 minutes, start Monomer Feed and Pre-Emulsion. Monomer Feed
at 2.93 g/min (792.4 g) (270 min) and Pre-Emulsion at 0.57 g/min (154.7 g)
(270 min).
5. Wait 30 minutes after Activation Feed added, then add Post Add. Wait
one hour after Post Add added, then dilute to 4% and start cooling and
discharge.

TABLE 14
Sample 19

| | grams |
|---|---|
| Reactor Charge | |
| Mowiol 4/88 (15%) | 28.9 |
| Disponyl FES 77(32%) | 0.28 |
| NaFe EDTA | 0.02 |
| TBHP 70 | 0.28 |
| Deionized Water | 197.3 |
| Monomer Feed | |
| Deionized Water | 559.2 |
| 2-Hydroxyethyl Methcrylate | 267.0 |
| TBHP 70 | 1.41 |
| Pre-Emulsion | |
| Deionized Water | 28.2 |
| Disponyl FES 77 (32%) | 12.7 |
| Mowiol 4/88 (15%) | 28.9 |
| NH₃ (19%) | 7.0 |
| 2-EHA | 39.2 |
| Methyl Methacrylate | 39.2 |
| Methacrylic Acid | 10.7 |
| Activator Feed | |
| Deionized Water | 50.0 |
| Buggolite E01 | 0.99 |
| Post Add | |
| TBHP 70 | 0.71 |
| Acticide GA | 0.40 |
| Deionized Water | 7.05 |
| Rinse Water | |
| Deionized Water | 15.00 |
| Dilution | |
| Deionized Water | 130.60 |
| Total | 1425.0 |

Procedures
1. Add Reactor Charge and heat to 53-55° C., with a 55° C. bath. Wait
approximately 15 to 30 minutes.
2. Add 35.2 g Monomer Feed and 11.1 g Pre-Emulsion.
3. Start Activator Feed at 0.17 g/min (51.0 g) (300 minutes).
4. After 10 minutes start Monomer Feed and Pre-Emulsion with Monomer
Feed at 2.90 g/min (792.4 g) (270 min) and Pre-Emulsion at 0.57 g/min
(154.7 g) (270 min).
5. Wait thirty minutes after Activator Feed added and then add Post Add.
Wait one hour and then dilute to 4% and start cooling and discharge.

The emulsion samples 20, 21 and 22 evaluated were prepared in accordance with the following general procedures and using the approximate parameters indicated in Table 15 below:
1. Add the Reactor Initial Charge and heat the batch to 55° C.;
2. Add 1.1 gram of Pre-emulsion and 68.8 gram of Monomer Feed to the reactor;
3. Hold the batch to allow the batch temperature to equilibrate to 55° C.;
4. Start the Activator Feed at 0.17 g/min for 15 minutes;
5. Co-feed the Monomer Feed and the Pre-emulsion feed for 270 minutes;
6. After the Activator Feed, cook the batch for 30 minutes;
7. Add Post-Add and hold for another 60 minutes;
8. Cool down the batch and add biocides, rinse and dilution.

TABLE 15

| | Sample 20 | Sample 21 | Sample 22 |
|---|---|---|---|
| | Charge | Charge | Charge |
| | (gram) | (gram) | (gram) |
| Reactor Initial Charge | | | |
| BP-04 (15%) | 34.3 | 34.3 | 34.3 |
| NaFe EDTA | 0.02 | 0.02 | 0.02 |
| t-BHP, 70% | 0.20 | 0.20 | 0.20 |
| Deionized Water | 190.5 | 190.5 | 190.5 |
| Monomer Feed | | | |
| Deionized Water | 547.0 | 547.0 | 547.0 |
| 2-Hydroxyethyl | | | |
| Methacrylate | 262.0 | 262.0 | 262.0 |
| t-BHP, 70% | 0.83 | 0.83 | 0.83 |
| Pre-Emulsion | | | |
| Deionized Water | 21.5 | 21.5 | 21.5 |
| Disponil FES 77 (32%) | 15.2 | 15.2 | 15.2 |
| BP-04 (15%) | 34.3 | 34.3 | 34.3 |
| Ammonia, 19% | 16.0 | 16.0 | 16.0 |
| 2-Ethylhexyl Acrylate | 48.1 | 57.8 | 67.4 |
| Methyl Methacrylate | 28.9 | 19.3 | 9.6 |
| Methacrylic Acid | 10.5 | 10.5 | 10.5 |
| Activator Feed, solids | | | |
| Deionized Water | 49.6 | 49.6 | 49.6 |
| Bruggolite E01 | 1.00 | 1.00 | 1.00 |
| Post Add | | | |
| t-BHP, 70% | 0.20 | 0.20 | 0.20 |
| Deionized Water | 2.00 | 2.00 | 2.00 |
| Bruggolite E01 | 0.19 | 0.19 | 0.19 |
| NaFe EDTA | 0.01 | 0.01 | 0.01 |
| Deionized Water | 5.00 | 5.00 | 5.00 |
| Biocides | | | |
| Acticide GA | 0.40 | 0.40 | 0.40 |
| Deionized Water | 6.90 | 6.90 | 6.90 |
| Rinse Water | | | |
| Deionized Water | 14.70 | 14.70 | 14.70 |
| Dilution | | | |
| Deionized Water | 110.70 | 110.70 | 110.70 |
| Grand Total | 1400.1 | 1400.2 | 1400.1 |

In addition, in some embodiments, the dry donning performance of a coating can be further improved by the acid monomer, such as methacrylic acid, in the monomer feed and/or the pre-emulsion feed. By way of example, the emulsion samples 23, 24 and 25 evaluated were prepared based upon the Table 16 below in accordance with the following general procedures and using the approximate parameters indicated below:
1. Add the Reactor Initial Charge and heat the batch to 55° C.;
2. Add 1.1 gram of Pre-emulsion and 68.8 gram of Monomer Feed to the reactor;
3. Hold the batch to allow the batch temperature to equilibrate to 55° C.;
4. Start the Activator Feed at 0.17 g/min for 15 minutes;
5. Co-feed the Monomer Feed and the Pre-emulsion feed for 270 minutes;
6. After the Activator Feed, cook the batch for 30 minutes;
7. Add Post-Add and hold the batch for another 60 minutes;
8. Cool down the batch and add biocides, rinse and dilution.

TABLE 16

| | Sample 23 | Sample 24 | Sample 25 |
|---|---|---|---|
| | Charge | Charge | Charge |
| | (gram) | (gram) | (gram) |
| Reactor Initial Charge | | | |
| BP-04 (15%) | 33.7 | 33.7 | 33.7 |
| NaFe EDTA | 0.02 | 0.02 | 0.02 |
| t-BHP, 70% | 0.20 | 0.20 | 0.20 |
| Deionized Water | 191.1 | 191.1 | 191.1 |
| Monomer Feed | | | |
| Deionized Water | 547.0 | 547.0 | 547.0 |
| 2-Hydroxyethyl | | | |
| Methacrylate | 262.0 | 262.0 | 262.0 |
| t-BHP, 70% | 0.83 | 0.83 | 0.83 |
| Pre-Emulsion | | | |
| Deionized Water | 34.1 | 18.0 | 10.0 |
| Disponil FES 77 (32%) | 15.2 | 15.2 | 15.2 |
| BP-04 (15%) | 33.7 | 33.7 | 33.7 |
| Ammonia, 19% | 8.0 | 24.0 | 32.0 |
| 2-Ethylhexyl Acrylate | 41.1 | 35.9 | 33.3 |
| Methyl Methacrylate | 41.1 | 35.9 | 33.3 |
| Methacrylic Acid | 5.3 | 15.8 | 21.0 |
| Activator Feed | | | |
| Deionized Water | 49.6 | 49.6 | 49.6 |
| Bruggolite E01 | 1.00 | 1.00 | 1.00 |
| Post Add | | | |
| t-BHP, 70% | 0.40 | 0.40 | 0.40 |
| Deionized Water | 1.80 | 1.80 | 1.80 |
| Bruggolite E01 | 0.19 | 0.19 | 0.19 |
| NaFe EDTA | 0.01 | 0.01 | 0.01 |
| Deionized Water | 5.00 | 5.00 | 5.00 |
| Biocides | | | |
| Acticide GA | 0.40 | 0.40 | 0.40 |
| Deionized Water | 6.90 | 6.90 | 6.90 |
| Rinse Water | | | |
| Deionized Water | 10.60 | 10.60 | 10.60 |
| Dilution | | | |
| Deionized Water | 180.70 | 180.70 | 180.70 |
| Grand Total | 1470.0 | 1470.0 | 1400.1 |

In embodiments for rubber or latex gloves, the gloves may require the ability of donning, i.e, the ability to slide a glove on and off the surface of the skin, with minimal friction. As such, a flexible, non-tacky glove coating applied to the interior of a glove may be useful to allow donning, wet or dry, of the glove with minimal blocking and without undue friction or clinging. Thus, for these and/or other considerations, comparative testing of the foregoing coating samples above was performed by coating latex films with the sample coatings, wherein one sample coating was applied to each film. Prior to application to the film, solvent-based coating samples were diluted to approximately 4% total solid concentration using a mixture of methanol and ethyl acetate, and the emulsion and water soluble coatings were diluted with deionized water to approximately 4% total solid concentration. Then, for samples indicated as having a crosslinker, the indicated crosslinker was added to the copolymer. The polymer solution was then coated on latex film using a standard dipping procedure. Subsequently, the coated film was chlorinated with chlorine strength of about 100 parts per millions in order to remove any powder and reduce the surface tackiness.

The samples were tested to determine their dry static and kinetic coefficients of friction (“COF”) and also to determine their levels of stickiness and smoothness. The results are reported below in Table 17 for solvent-based polymer coatings, Table 18 for water-soluble polymer coatings, and Table 19 for polymeric emulsions.

TABLE 17

| | Sample | Sample | Sample | Sample |
|---|---|---|---|---|
| | 8 | 9 | 10 | 11 |
| | Solvent | Solvent | Solvent | Solvent |
| 2-hydroxethyl | 68 | 93 | 95 | 75 |
| methacrylate | | | | |
| 2-ethylhexyl acrylate | 23 | 5 | 5 | 25 |
| methacrylic acid | 9 | 2 | | |
| 4-hydroxybutyl acrylate | | | | |
| 2-ethylhexyl methacrylate | | | | |
| lauryl methacrylate | | | | |
| methyl methacrylate | | | | |
| total | 100 | 100 | 100 | 100 |
| Crosslinker added | 2% | 2% | 0.5% | 0.5% |
| | XC113 | XC113 | Tyzor AA | Tyzor AA |
| Test Data | | | | |
| COF—Static | 0.09 | 0.10 | 0.03 | 0.08 |
| COF—Kinetic | 0.07 | 0.09 | 0.03 | 0.07 |
| Stickness—Formed | non tacky | non tacky | non tacky | non tacky |
| Stickness—Chlorinated | non tacky | non tacky | non tacky | non tacky |
| Smoothness—Formed | smooth | smooth | smooth | smooth |
| Smoothness—Chlorinated | smooth | smooth | smooth | smooth |

TABLE 18

| | Sample 1 | Sample 2 | Sample 3 | Sample 4 | Sample 5 | Sample 6 | Sample 7 |
|---|---|---|---|---|---|---|---|
| | Water | Water | Water | Water | Water | Water | Water |
| | Soluble | Soluble | Soluble | Soluble | Soluble | Soluble | Soluble |
| 2-hydroxyethyl | 60 | 60 | 90 | 90 | 97 | 87 | 87 |
| methacrylate | | | | | | | |
| 2-ethylhexyl | | | | | | | |
| acrylate | | | | | | | |
| methacrylic | 10 | 10 | 10 | 10 | 3 | 10 | 10 |
| acid | | | | | | | |
| 4-hydroxybutyl | 30 | 30 | | | | 3 | 3 |
| acrylate | | | | | | | |
| 2-ethylhexyl | | | | | | | |
| methacrylate | | | | | | | |
| methyl | | | | | | | |
| methacrylate | | | | | | | |
| total | 100 | 100 | 100 | 100 | 100 | 100 | 100 |
| Crosslinker | N/A | 2% | N/A | 2% | 2% | 2% | 2% |
| added | | Polycup | | Polycup | Polycup | Polycup | XC113 |
| | | 172 | | 172 | 172 | 172 | |
| Test Data | | | | | | | |
| COF - Static | 2.23 | N/R | 2.18 | N/R | 0.18 | N/R | 0.62 |
| COF - Kinetic | 0.69 | N/R | 0.6 | N/R | 0.48 | N/R | 0.46 |
| Stickiness - | tacky | tacky | tacky | tacky | non | tacky | non |
| Formed | | | | | tacky | | tacky |
| Stickiness - | tacky | tacky | tacky | tacky | non | tacky | non |
| Chlorinated | | | | | tacky | | tacky |
| Smoothness - | draggy | draggy | draggy | draggy | less | draggy | less |
| Formed | | | | | draggy | | draggy |
| Smoothness - | draggy | draggy | draggy | draggy | less | draggy | less |
| Chlorinated | | | | | draggy | | draggy |

TABLE 19

| | Sample | Sample | Sample | Sample | Sample | Sample | Sample | Sample |
|---|---|---|---|---|---|---|---|---|
| | 12 | 13 | 14 | 15 | 16 | 17 | 19 | 18 |
| | Emulsion | Emulsion | Emulsion | Emulsion | Emulsion | Emulsion | Emulsion | Emulsion |
| 2-hydroxyethyl | 75 | 75 | 75 | 75 | 75 | 75 | 75 | 75 |
| methacrylate | | | | | | | | |
| 2-ethylhexyl | 22 | 22 | 22 | | | | 11 | |
| acrylate | | | | | | | | |
| methacrylic | 3 | 3 | 3 | 3 | 3 | 3 | 3 | 3 |
| acid | | | | | | | | |
| 4-hydroxybutyl | | | | | | | | |
| acrylate | | | | | | | | |
| 2-ethylhexyl | | | | 22 | 22 | | | |
| methacrylate | | | | | | | | |
| lauryl | | | | | | 22 | | 22 |
| methacrylate | | | | | | | | |
| methyl | | | | | | | 11 | |
| methacrylate | | | | | | | | |
| total | 100 | 100 | 100 | 100 | 100 | 100 | 100 | 100 |
| Crosslinker | N/A | 2% | 2% | 2% | 2% | 2% | 2% | 2% |
| added | | Polycup | Carb. | Polycup | Carb. | Polycup | Carb. | Polycup |
| | | 172 | E-02 | 172 | E-02 | 172 | E-02 | 172 |
| Test Data | | | | | | | | |
| COF - Static | 0.97 | 0.39 | 1.5 | 0.69 | 0.74 | Tacky at | 0.05 | 0.74 |
| COF - Kinetic | 0.95 | 0.45 | 1.45 | 1.02 | 0.82 | formed | 0.12 | 0.5 |
| | | | | | | level | | |
| Stickiness - | non | non | non | non | non | tacky | non | non |
| Formed | tacky | tacky | tacky | tacky | tacky | | tacky | tacky |
| Stickiness - | non | non | non | non | non | Not | non | non |
| Chlorinated | tacky | tacky | tacky | tacky | tacky | chlorinated | tacky | tacky |
| Smoothness - | less | less | less | less | less | | less | less |
| Formed | draggy | draggy | draggy | draggy | draggy | | draggy | draggy |
| Smoothness - | less | less | less | less | less | | less | less |
| Chlorinated | draggy | draggy | draggy | draggy | draggy | | draggy | draggy |

The following Tables 20-23 show the results of additional experiments testing the coefficients of friction (“COF”) for Samples A-G, which are polymeric emulsions containing HEMA/EHA/MMA/MAA (75/11/11/3). The coating refers to % total solid content (TSC), and CYMEL® 373 refers to a methylated melamine-formaldehyde crosslinker available from Cytec Industries of Woodland Park, N.J.

TABLE 20

| | SAMPLE | | | | | | | |
|---|---|---|---|---|---|---|---|---|
| | A | | | | B | | | |
| Coating TSC (%) | 4.0 | | | | 4.0 | | | |
| CYMEL ® 373 (%) | 4.0 | | | | 3.5 | | | |
| Acid Priming (HCl %) | 0 | | | | 0 | | | |
| Coefficient of Friction | | | Donning | | | | Donning | |
| (COF) | Donning Palm | | Finger | | Donning Palm | | Finger | |
| Sample | Static | Kinetic | Static | Kinetic | Static | Kinetic | Static | Kinetic |
| Average | 0.04 | 0.04 | 0.08 | 0.09 | 0.04 | 0.06 | 0.08 | 0.09 |
| Std Dev | 0.01 | 0.01 | 0.07 | 0.09 | 0.01 | 0.01 | 0.00 | 0.01 |

| | | |
|---|---|---|
| Physical Properties of | | |
| Chlorinated | | |
| Gloves (Unaged) | | |
| Tensile Strength (kg/cm²) | 280 | 281 |
| Stress 300% (kg/cm²) | 17 | 15 |
| Stress 500% (kg/cm²) | 49 | 38 |
| Ultimate Elongation % | 845 | 885 |
| Powder Content | | |
| Powder Content | Not tested | 1.22 |
| (mg/glove) | | |
| Observations | | |
| Coating Evenness | Fair | Fair |
| *Degree of Coating | 4 | 4 |
| Flaking | | |

TABLE 21

| | SAMPLE | | | | | | | |
|---|---|---|---|---|---|---|---|---|
| | C | | | | D | | | |
| Coating TSC (%) | 4.0 | | | | 4.0 | | | |
| CYMEL ® 373 (%) | 3.5 | | | | 3.5 | | | |
| Acid Priming (HCl %) | 0.03 | | | | 1.5 | | | |
| Coefficient of Friction | | | Donning | | | | Donning | |
| (COF) | Donning Palm | | Finger | | Donning Palm | | Finger | |
| Sample | Static | Kinetic | Static | Kinetic | Static | Kinetic | Static | Kinetic |
| Average | 0.03 | 0.04 | 0.06 | 0.08 | 0.02 | 0.03 | 0.04 | 0.08 |
| Std Dev | 0.01 | 0.01 | 0.02 | 0.02 | 0.01 | 0.01 | 0.00 | 0.01 |

| | | |
|---|---|---|
| Physical Properties of | | |
| Chlorinated | | |
| Gloves (Unaged) | | |
| Tensile Strength (kg/cm²) | 254 | 243 |
| Stress 300% (kg/cm²) | 14 | 15 |
| Stress 500% (kg/cm²) | 32 | 34 |
| Ultimate Elongation % | 845 | 924 |
| Powder Content | | |
| Powder Content | Not tested | 0.86 |
| (mg/glove) | | |
| Observations | | |
| Coating Evenness | Good | Good |
| *Degree of Coating | 3 | 2 |
| Flaking | | |

TABLE 22

| | SAMPLE | | | | | | | |
|---|---|---|---|---|---|---|---|---|
| | E | | | | F | | | |
| Coating TSC (%) | 3.5 | | | | 3.5 | | | |
| CYMEL ® 373 (%) | 3.5 | | | | 3.5 | | | |
| Acid Priming (HCl %) | 0 | | | | 1.5 | | | |
| Coefficient of Friction | | | Donning | | | | Donning | |
| (COF) | Donning Palm | | Finger | | Donning Palm | | Finger | |
| Sample | Static | Kinetic | Static | Kinetic | Static | Kinetic | Static | Kinetic |
| Average | 0.08 | 0.08 | 0.04 | 0.05 | 0.03 | 0.04 | 0.07 | 0.07 |
| Std Dev | 0.08 | 0.07 | 0.04 | 0.04 | 0.02 | 0.02 | 0.03 | 0.03 |

| | | |
|---|---|---|
| Physical Properties of | | |
| Chlorinated | | |
| Gloves (Unaged) | | |
| Tensile Strength (kg/cm²) | 273 | 236 |
| Stress 300% (kg/cm²) | 15 | 11 |
| Stress 500% (kg/cm²) | 37 | 28 |
| Ultimate Elongation % | 845 | 924 |
| Powder Content | | |
| Powder Content | 1.56 | Not tested |
| (mg/glove) | | |
| Observations | | |
| Coating Evenness | Good | Excellent |
| *Degree of Coating | 3 | 2 |
| Flaking | | |

TABLE 23

| SAMPLE | G | | | |
|---|---|---|---|---|
| Coating TSC (%) | 3.5 | | | |
| CYMEL ® 373 (%) | 3.5 | | | |
| Acid Priming (HCl %) | 1.0 | | | |
| Coefficient of Friction | Donning | | Donning | |
| (COF) | Palm | | Finger | |
| Sample | Static | Kinetic | Static | Kinetic |
| Average | 0.05 | 0.05 | 0.04 | 0.05 |
| Std Dev | 0.02 | 0.00 | 0.00 | 0.00 |
| Physical Properties of | | | | |
| Chlorinated | | | | |
| Gloves (Unaged) | | | | |
| Tensile Strength ( kg/cm²) | 223 | | | |
| Stress 300% ( kg/cm²) | 11 | | | |
| Stress 500% ( kg/cm²) | 20 | | | |
| Ultimate Elongation % | 963 | | | |
| Powder Content | | | | |
| Powder Content | 0.78 | | | |
| (mg/glove) | | | | |
| Observations | | | | |

| | |
|---|---|
| Coating Evenness | Excellent |
| * Degree of Coating | 2 |
| Flaking | |

The stickiness and smoothness observed in the testing were recorded using a known solvent-based product having suitable performance on gloves as the reference. As shown by the results in Tables 17, 18, and 19, some exemplary emulsions generally provide comparable or lower coefficient of friction results. The exemplary emulsion coatings also provide improved stickiness and smoothness results as compared with water-based coatings. Sample 19 also provides comparable friction results as compared with solvent-based coatings. In addition, some emulsion samples provided comparable coefficient of friction results when compared with the solvent-based coatings. It is to be noted that some surface roughness of the coating may be desirable in certain embodiments, such as for coatings applied to gloves and other donning materials, because the roughness or morphology may provide for less contact between the material and the user's skin, which may provide desirable donning properties.

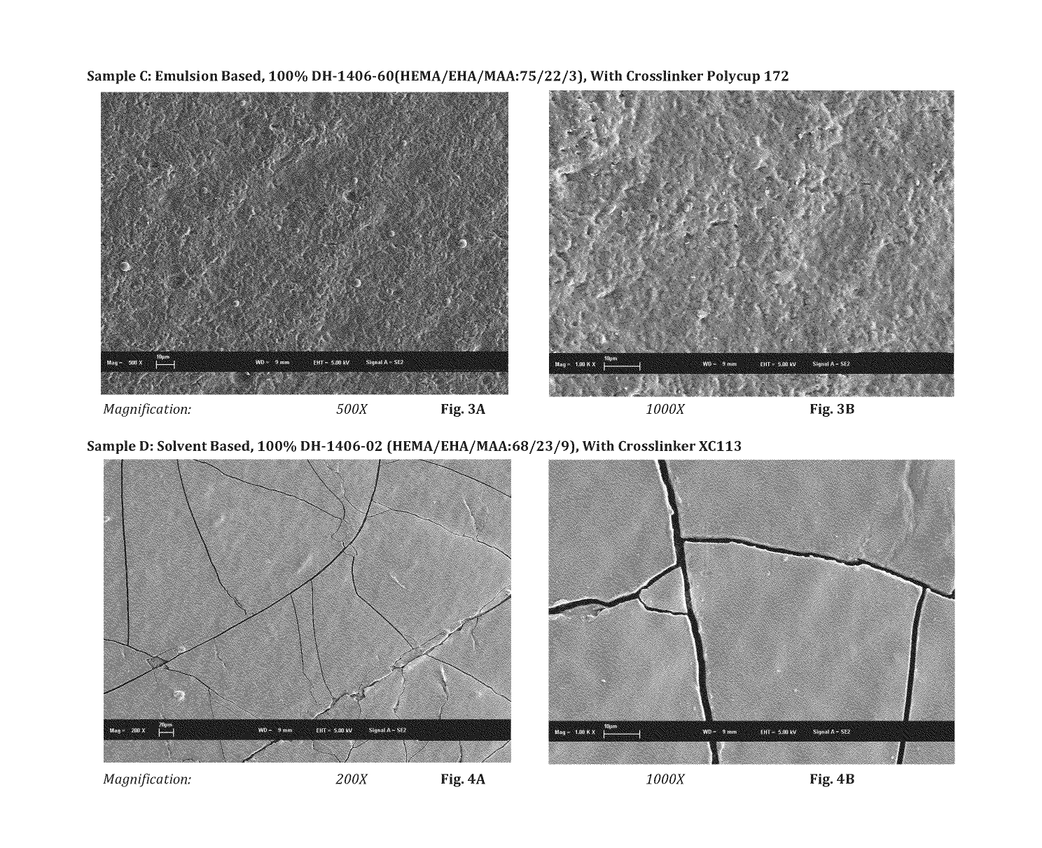

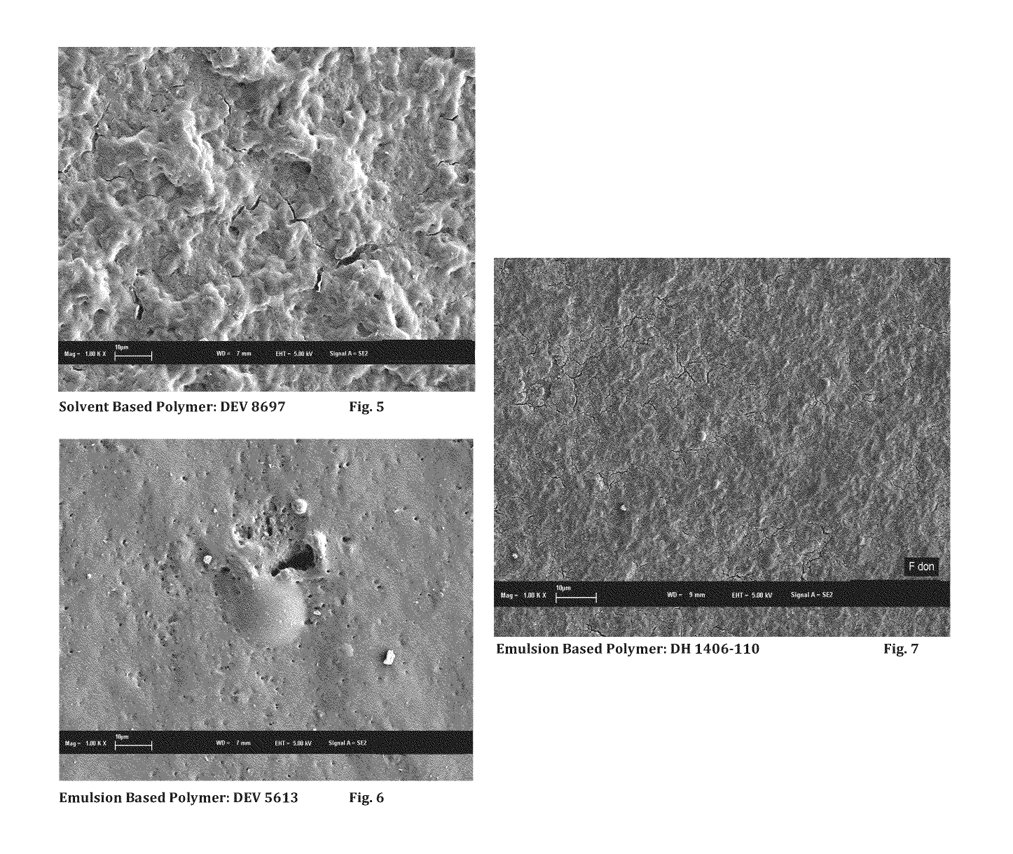

As shown in the accompanying figures, scanning electron microscopic images were obtained for some of the samples. FIGS. 3A and 3B are images of a film coated with an emulsion prepared using 75% 2-hydroxyethyl methacrylate, 22% 2-ethylhexyl acrylate, and 3% methacrylic acid. FIG. 6 is an image of a film coated with an emulsion prepared using 75% 2-hydroxyethyl methacrylate, 22% lauryl methacrylate, and 3% methacrylic acid, and FIG. 7 is an image of a film coated with an emulsion prepared using 75% 2-hydroxyethyl methacrylate, 22% lauryl methacrylate, and 3% methacrylic acid.

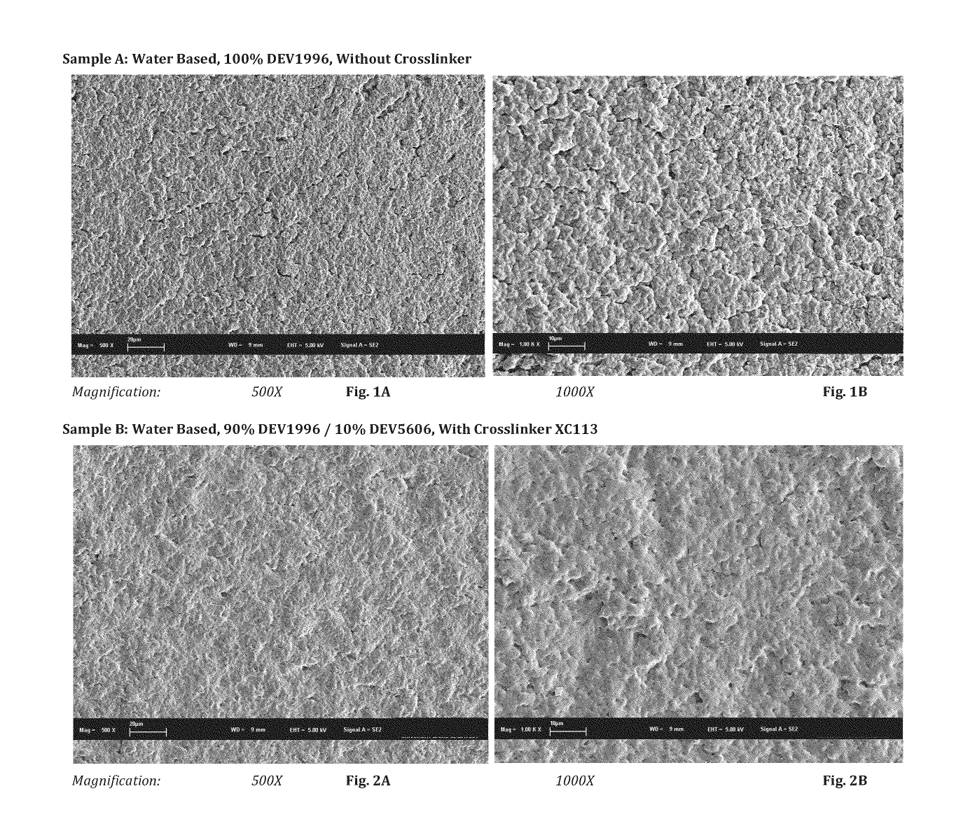

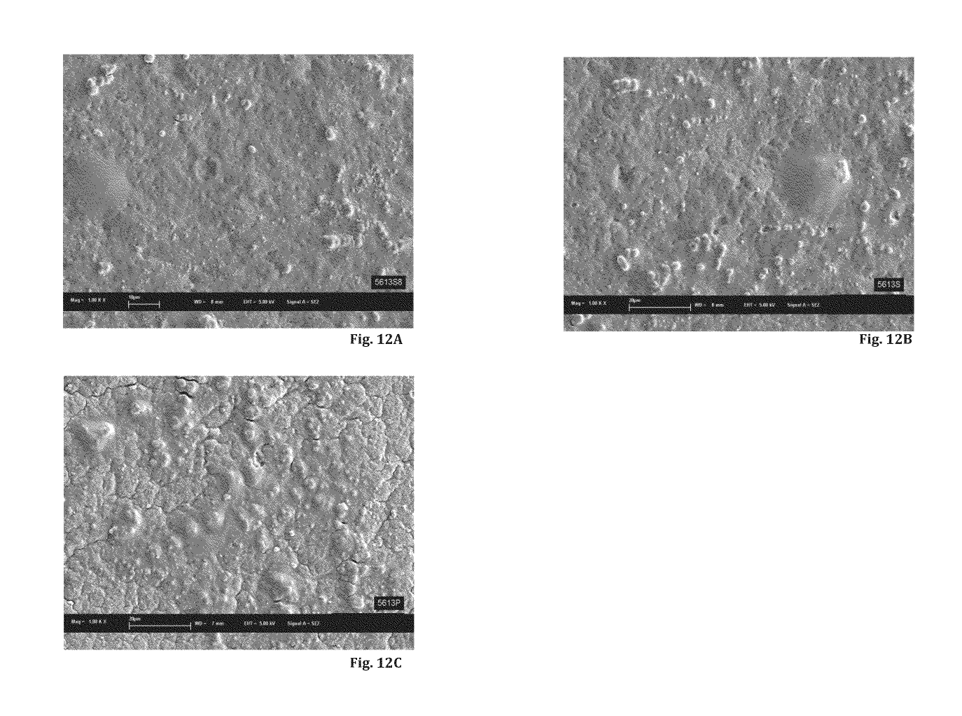

As shown in the referenced images, the coating on films using an emulsion as disclosed herein exhibits little cracking and provides a relatively smooth application. In particular, those emulsion coatings show less cracking and a smoother application to the film than the samples employing water-based coatings shown in FIGS. 1A, 1B, 2A, and 2B. In addition, the emulsion coatings also advantageously exhibit less cracking and less severe cracking as compared with the film having a solvent-based coating shown in FIGS. 4A and 4B. The emulsion coatings also evidence a smoother application and less severe cracking as compared with the film having a solvent-based coating in FIG. 5. These results are also demonstrated by the emulsion coating shown in FIGS. 12A, 12B, and 12C, which are discussed in detail below.

Additional physical properties were also determined for certain testing samples. Also, a control solvent-based coating was used for comparison testing, wherein the control is known to be effective in glove coating applications. These physical properties are recorded in the following table, and any referenced crosslinker was added at 2% based upon the dry weight of the crosslinker to the dry weight of the copolymer. As indicated by those results, emulsions formed in accordance with the disclosure herein provide comparable or favorable stretch and strength characteristics when compared with solvent-based and water-based coatings. These emulsions also provide cost savings and reduced pollutants as compared with solvent-based coatings.

TABLE 24

| Polymer base | | | | | | | |
|---|---|---|---|---|---|---|---|
| Solvent | Water | | | Emulsion | | Solvent | |
| Coating Type | | | | | | | |
| | Sample 1 | Sample 3 | | Sample | Sample | | |
| Control | (soft) | (hard) | Sample 7 | 12 | 13 | Sample 8 | Sample 9 |

| Crosslinker | | | | | | |
|---|---|---|---|---|---|---|
| Not | | | Not | Polycup | | |
| added | Not added | XC113 | added | 173 | XC113 | XC113 |

Formed level

| | | | | | | | | |
|---|---|---|---|---|---|---|---|---|
| Tensile Strength (kg/cm²) | 271 | 215 | 216 | Not tested | 280 | 264 | Not | Not |
| | | | | | | | tested | tested |
| Modulus @ 300% (kg/cm2) | 12 | 18 | 20 | Not tested | 19 | 18 | Not | Not |
| | | | | | | | tested | tested |
| Modulus @ 500% (kg/cm2) | 31 | 51 | 62 | Not tested | 50 | 46 | Not | Not |
| | | | | | | | tested | tested |
| Ultimate Elongation (%) | 904 | 845 | 766 | Not tested | 845 | 845 | Not | Not |
| | | | | | | | tested | tested |

Chlorinated level

| | | | | | | | | |
|---|---|---|---|---|---|---|---|---|
| Tensile Strength (kg/cm²) | 317 | 288 | 282 | 256 | 328 | 290 | 255 | 267 |
| Modulus @ 300% (kg/cm2) | 13 | 15 | 14 | 21 | 18 | 16 | 17 | 20 |
| Modulus @ 500% (kg/cm2) | 36 | 40 | 37 | 51 | 42 | 38 | 43 | 45 |
| Ultimate Elongation (%) | 884 | 845 | 845 | 865 | 845 | 884 | 825 | 825 |

The nano-hardness and reduced modulus were also measured for some of the foregoing samples by nano-indention testing, which provided the following results, as shown in Table 25.

TABLE 25

| Polymerbase | Hardness (GPa) | Reduced Modulus (GPa) |
|---|---|---|
| Emulsion | 0.072 | 1.969 |
| Sample 13 (2% Polycup 172) | | |
| Emulsion | 0.069 | 1.861 |
| Sample 17 (2% Polycup 172) | | |
| Emulsion | 0.055 | 1.977 |
| Sample 18 (2% Polycup 172) | | |
| Solvent | 0.023 | 0.611 |
| Sample 11 | | |

Testing, including flaking observation, was performed on latex films coated with Samples 19, 20, 21 and 22 and an acid priming step comprising an HCl solution of 1% using the following procedures:
1. The emulsion-based copolymer was diluted with deionized (“DI”) water to 3.5-4.0% of the total solids content (“TSC”).
2. 3.5-4.0% of the crosslinker Cymel 373 was added to the Sample 19, 20, 21 and 22 emulsion based on dry weight of the crosslinker to the dry weight of the copolymer.
3. The polymer solution was chilled and maintained at about 34° C.
4. Prior to the application of the polymer coating, the glove sample was pre-treated by dipping into an HCl acid priming solution and dried in the oven at 100° C. to 150° C. for 1 to 2 minutes.
5. The polymer solution was then coated onto the pre-treated latex film, the latex film being heated up to a temperature of about 40-45° C. prior to the coating process.
6. After coating, the mold upon which the film was applied was rotated in the oven to ensure even coating on the film.
7. The coated film was then cured at 140° C. for 30 minutes.
8. The coated film was then chlorinated on the donning and/or patient side to remove any powder with chlorine strength of about 80 ppm.
9. The coated films were then tested as indicated in the table below. The aged samples were aged using a heat accelerated aging process, as specified in ASTM D-412 method, in which the aged gloves were placed in an oven for 7 days at about 70° C. The unaged samples were tested without performing such a heat treatment aging process.

Based upon the testing procedures above, the following results were obtained as shown in Table 26 below, wherein the degree of coating flaking was evaluated on a scale of 1 to 5 with 1 indicating the lowest flake and 5 indicating the highest flake. As can be seen, the degree of flaking and the characteristic performance of a coating can be controlled by the ratio of “hard” monomers to “soft” monomers.

TABLE 26

| Coating | Sample 19 | | | | Sample 20 | | | | Sample 21 | | | | Sample 22 | | | |
|---|---|---|---|---|---|---|---|---|---|---|---|---|---|---|---|---|
| Coating TSC | 3.5 | | | | 3.5 | | | | 3.5 | | | | 3.5 | | | |
| (%) | | | | | | | | | | | | | | | | |
| Cymel 373 (%) | 3.5 | | | | 3.5 | | | | 3.5 | | | | 3.5 | | | |
| Acid Priming | 1 | | | | 1 | | | | 1 | | | | 1 | | | |
| (% HCl) | | | | | | | | | | | | | | | | |
| Coefficient of | | | | | | | | | | | | | | | | |
| Friction (COF) | Donning Palm | | Donning Finger | | Donning Palm | | Donning Finger | | Donning Palm | | Donning Finger | | Donning Palm | | Donning Finger | |
| Sample | Static | Kinetic | Static | Kinetic | Static | Kinetic | Static | Kinetic | Static | Kinetic | Static | Kinetic | Static | Kinetic | Static | Kinetic |
| Average | 0.11 | 0.09 | 0.05 | 0.06 | 0.27 | 0.30 | 0.21 | 0.19 | 0.3 | 0.29 | 0.13 | 0.15 | 0.39 | 0.36 | 0.17 | 0.15 |
| Std Dev | 0.03 | 0.02 | 0.02 | 0.04 | 0.15 | 0.17 | 0.18 | 0.15 | 0.18 | 0.20 | 0.03 | 0.03 | 0.33 | 0.31 | 0.03 | 0.05 |

| | | | | |
|---|---|---|---|---|
| Physical | | | | |
| Properties | | | | |
| of Sterile | | | | |
| Gloves | | | | |
| (Unaged) | | | | |
| Tensile | 261 | 256 | 260 | 252 |
| Strength | | | | |
| (kg/cm²) | | | | |
| Stress 300% | 11 | 11 | 14 | 12 |
| (kg/cm²) | | | | |
| Stress 500% | 24 | 27 | 32 | 30 |
| (kg/cm²) | | | | |
| Ultimate | 884 | 924 | 924 | 924 |
| Elongation % | | | | |
| Physical | | | | |
| Properties | | | | |
| of Sterile | | | | |
| Gloves (Aged) | | | | |
| Tensile | 198 | 195 | 220 | 194 |
| Strength | | | | |
| (kg/cm²) | | | | |
| Stress 300% | 10 | 8 | 11 | 12 |
| (kg/cm²) | | | | |
| Stress 500% | 21 | 14 | 30 | 27 |
| (kg/cm²) | | | | |
| Ultimate | 884 | 884 | 884 | 884 |
| Elongation % | | | | |
| Observations | | | | |
| Coating | Not Tested | No | No | No |
| Sedimentation | | | | |
| Internal Tacky | Not Tested | Slightly | No | Slightly |
| during | | | | |
| Processing | | | | |
| Dry donning | Good | Good | Good with inconsistency | Good with inconsistency |
| *Degree of | 1 | 1 | 2 | 1 |
| Coating | | | | |
| Flaking | | | | |

Testing, including flaking observation, was performed on latex films coated with Sample 19, 23, 24 and 25 using the following procedures:
1. The emulsion-based copolymer was diluted with deionized (“DI”) water to 3.5-4.0% of the total solids content (“TSC”).
2. 3.5-4.0% of the crosslinker Cymel 373 was added to the Sample 19, 23, 24 and 25 emulsion based on dry weight of the crosslinker to the dry weight of the copolymer.
3. The polymer solution was chilled and maintained at about 34° C.
4. Prior to application of the polymer coating, the glove sample was pre-treated by dipping in an Aluminium Sulphate priming solution and dried in the oven at 100° C. to 150° C. for 1 to 2 minutes.
5. The polymer solution was coated on the pre-treated latex film, the latex film being heated up to a temperature of about 40-45° C. prior to the coating process.
6. After coating, the mold upon which the film was applied was rotated in the oven to ensure even coating on the film.
7. The coated film was then cured at 140° C. for 30 minutes.
8. The coated film was then chlorinated on the donning and/or patient side to remove any powder with chlorine strength of about 80 ppm.
9. The coated films were then tested as indicated in the table below. The aged samples were aged using a heat accelerated aging process, as specified in ASTM D-412 method. In general, the aged gloves were placed in an oven for 7 days at about 70° C. The unaged samples were tested without performing such a heat treatment aging process.

Based upon the testing procedures above, the following results were obtained, as shown in Table 27 below, wherein the degree of coating flaking was evaluated on a scale of 1 to 5 with 1 indicating the lowest flake and 5 indicating the highest flake. As can be seen, the best dry donning performance was achieved at 1.5% (wt/wt) methacrylic acid level (MAA), as exhibited with Sample 23. Overall, the best physical properties exhibited for both aged and unaged, were observed with Sample 23.

TABLE 27

| Coating | Sample 19 | | | | Sample 23 | | | | Sample 24 | | | | Sample 25 | | | |
|---|---|---|---|---|---|---|---|---|---|---|---|---|---|---|---|---|
| Coating TSC | 3.5 | | | | 3.5 | | | | 3.5 | | | | 3.5 | | | |
| (%) | | | | | | | | | | | | | | | | |
| Cymel 373 (%) | 3.5 | | | | 3.5 | | | | 3.5 | | | | 3.5 | | | |
| Aluminum | 1.5% | | | | 1.5% | | | | 1.5% | | | | 1.5% | | | |
| sulphate | | | | | | | | | | | | | | | | |
| Priming | | | | | | | | | | | | | | | | |
| Coefficient of | Donning | | Donning | | Donning | | Donning | | | | Donning | | Donning | | Donning | |
| Friction (COF) | Palm | | Finger | | Palm | | Finger | | Donning Palm | | Finger | | Palm | | Finger | |
| Sample | Static | Kinetic | Static | Kinetic | Static | Kinetic | Static | Kinetic | Static | Kinetic | Static | Kinetic | Static | Kinetic | Static | Kinetic |
| Average | 0.16 | 0.17 | 0.34 | 0.33 | 0.13 | 0.14 | 0.03 | 0.04 | 0.08 | 0.08 | 0.02 | 0.04 | 0.18 | 0.21 | 0.08 | 0.09 |
| Std Dev | 0.04 | 0.04 | 0.33 | 0.33 | 0.00 | 0.00 | 0.00 | 0.00 | 0.03 | 0.02 | 0.00 | 0.03 | 0.03 | 0.07 | 0.04 | 0.04 |

| | | | | |
|---|---|---|---|---|
| Physical | | | | |
| Properties | | | | |
| of Sterile | | | | |
| Gloves | | | | |
| (Unaged) | | | | |
| Tensile | 289 | 274 | 280 | 268 |
| Strength | | | | |
| (kg/cm²) | | | | |
| Stress 300% | 11 | 12 | 11 | 12 |
| (kg/cm²) | | | | |
| Stress 500% | 25 | 24 | 24 | 29 |
| (kg/cm²) | | | | |
| Ultimate | 924 | 924 | 943 | 924 |
| Elongation % | | | | |
| Physical | | | | |
| Properties | | | | |
| of Sterile | | | | |
| Gloves (Aged) | | | | |
| Tensile | 287 | 280 | 302 | 277 |
| Strength | | | | |
| (kg/cm²) | | | | |
| Stress 300% | 12 | 11 | 12 | 12 |
| (kg/cm²) | | | | |
| Stress 500% | 29 | 24 | 27 | 26 |
| (kg/cm²) | | | | |
| Ultimate | 943 | 943 | 924 | 884 |
| Elongation % | | | | |
| Powder content | 1.82 | 1.46 | 1.42 | 1.40 |
| (mg/glove) | | | | |
| Observations | | | | |
| Coating | No | No | Yes | Yes |
| sedimentation | | | | |
| Internal tacky | Slightly | No | Yes | Yes |
| during | | | | |
| processing | | | | |
| Dry donning | Fair | Best among samples | Fair | Fair |
| *Degree of | 2 | 2 | 2 | 2 |
| Coating | | | | |
| Flaking | | | | |

In some embodiments, the emulsion coatings may be applied to an article, such as latex or rubber gloves. The article may be formed by any methods known in the art, such as those described in U.S. Pat. No. 4,548,844, U.S. Pat. No. 6,673,404, U.S. Pat. No. 6,828,387, and U.S. Pat. No. 8,110,266, each of which is incorporated by reference in its entirety. In some embodiments wherein the article is a glove, the glove may be formed by dipping processes known in the art. During the manufacture of those gloves, a hand mold (also called a “glove mold” or mandrel) may be used for dipping. The mandrel may be a porcelain mold in the shape of a hand. As referenced above and in additional data herein, the “formed level” refers to the article production process in which the mold first has a release coating directly applied to the mold followed by dipping in latex to form the glove. Then a coating, such as the solvent-based, water-based, or emulsion copolymers discussed herein, may be applied on the latex, such as on the donning side of the glove.

In some embodiments wherein a glove is formed about a mold, the mold may first be cleaned with a material, such as citric acid. Then the mold may be dipped into a coagulant material, dried, and then further dipped into a liquid rubber material such as latex. The rubber coated mold may then be dried and then dipped into a leaching solution. The leaching solution may allow coagulant salts to dissolve and/or be washed away.

The glove may be molded with the patient side in contact with the mold and the donning side on the exterior. When the glove is removed from the mold, the glove is commonly inverted such that the donning side is then on the interior of the glove and the patient side is on the exterior.

In some embodiments, after the dipping of the rubber coated mold in a leaching solution, the rubber coated mold may be dried, for example, by air drying or by use of a dryer, and then subjected to an acid priming process. The acid priming process may comprise the application of acid to either side of the glove, preferably the side in which a coating is applied. The acid priming process may comprise dipping the rubber coated mold (i.e., the glove on the mold) into a liquid composition comprising an acid, such as sulfuric acid or hydrochloric acid. The acid may then be diluted, and in some embodiments, the liquid composition comprising an acid may comprise acid solutions up to 20%, more preferably up to about 5%, and still more preferably from 1% to about 4.5% (w/w). In other embodiments, it is preferable to provide an acid solution comprising 1% to about 3% by weight. In another embodiment, the glove may be dipped into a liquid composition comprising a solution of aluminum sulphate as the acid priming solution. The liquid composition in this embodiment can comprise aluminum sulphate in amounts of up to about 10% (w/w), more preferably up to about 7%, and still more preferably from 0.5% to about 3%. In other embodiments, it is preferable to provide amounts of aluminum sulphate from 0.5% to about 1.5%.

After the dipping of the rubber coated mold in the liquid composition, the rubber coated mold may be dipped or rinsed in a bath, such as an alkaline solution or preferably an aqueous solution. Unlike other processes in the art, the dipping or rinsing of the rubber coated mold into an alkaline solution, such as a solution comprising ammonia or ammonium hydroxide, is not required with the processes disclosed herein. This provides a benefit over other coating processes in the art. In processes utilizing an alkaline solution, an additional dipping tank is typically required to facilitate the alkaline dipping, and it requires additional efforts to control the required concentration pH of the alkaline solution during an actual continuous dipping process. The process disclosed herein, which can be accomplished with rinsing in an aqueous bath, is more cost efficient while providing an adequate rinsing of any excessive acid on a rubber coated mold.

The coating of the formed article, such as a glove, may comprise the application of a coating material, such as a formulation comprising the copolymer emulsion described above. In some embodiments, the temperature of the glove mold may be adjusted prior to the application of the coating material. In some embodiments, the glove mold is brought to a temperature of preferably about 20° C. to 60° C., more preferably about 30° C. to 50° C., and most preferably about 35° C. to 45° C. In some embodiments, the glove mold is brought to these temperatures immediately prior to the application of the coating material. In some embodiments, the coating material is applied to the glove on the glove mold by dipping the mold, with the glove on it, into the coating material. Alternatively, the coating material may be sprayed onto the glove on the glove mold. In some embodiments, the glove is dipped into the coating material for a time period. In some embodiments, the time period is preferably about 2 to 120 seconds, more preferably about 5 to 90 seconds, even more preferably about 10 seconds to 60 seconds, and most preferably about 15 to 25 seconds. In some embodiments, the coating material is maintained at a temperature range during the application, preferably between about 15° C. to 75° C., more preferably between about 20° C. to 60° C., even more preferably between about 25° C. to 50° C., and most preferably between about 30° C. to 40° C. Since the glove on the mold is heated prior to dipping or coating with the polymer emulsion, the glove temperature can become quite hot. This may cause the temperature of the coating composition to rise, thus, it may be necessary to chill the coating composition during dipping in order to prevent or minimize increasing the temperature of the coating composition.

After the application of the coating material, the emulsion coated glove may be cured, for example, by heating in an oven. In some embodiments, the curing occurs with preset heating parameters for a time period, preferably about 5 minutes to 120 minutes, more preferably about 10 minutes to 90 minutes, even more preferably about 15 to 60 minutes, and most preferably about 20 to 40 minutes. In some embodiments, the air flow in the oven is controlled, for example, to remove excessive moisture. Unlike known processes in the art, wherein the curing step is required to occur at lower temperatures, the process disclosed herein may comprise a curing step that occurs at higher temperatures. This provides an advantage, as the use of higher temperatures in the curing process may allow for the use of a shorter curing time. In addition, in some embodiments, the use of higher temperatures allows for improved and optimal cross-linking for both the article, such as a latex glove, and the coating material, which can provide desired physical properties and adhesion. In some embodiments, the curing process occurs at a temperature of between about 100° C. to 160° C., more preferably about 120° C. to 150° C., and most preferably about 135° C. to 145° C. In preferred embodiments, the curing process occurs at a temperature of about 135° C. to 145° C., and the curing time is about 20 to 40 minutes. This is an improvement over other processes in the art, wherein the curing time can be much longer, typically two or more times as long.

Following the curing step, the emulsion coated gloves may be further treated by any methods known in the art. For example, in some embodiments, the emulsion coated gloves may be subjected to a post-cure leaching process wherein the mold containing the emulsion coated glove is dipped in a leaching solution and rinsed. In some embodiments, the emulsion coated glove may then be dipped in a further liquid, such as a slurry comprising silicone and/or calcium carbonate. In some processes, chlorination may be performed in which the coated glove may be washed in chlorinated water. In order to chlorinate the donning side, which may typically be on the interior of the glove after it is removed from the mold, a glove turning process is required in which the glove is turned inside out such that the donning side is on the exterior and the patient side is on the interior. One or both of the donning side and the patient side may be chlorinated. The chlorination step may remove any dip release coating, such as calcium carbonate, that may have been applied prior to molding the latex in order to assist with removing the glove from the mold. In addition, the chlorination process may create a roughened surface on the glove and/or harden the latex in some instances. The glove may be subjected to further treatment, such as a lubricating agent. Examples of lubricating agents include silicone and ammonium salts of alkyl phosphate and cetylpyridium chloride (CPC),

In one exemplary embodiment, a glove may be prepared by performing the following steps, in which some embodiments the steps may be performed in the exemplary order provided:
Cleaning the glove mold with a suitable acid (followed by optional rinsing);
Coagulent dipping (e.g., calcium nitrate), at a temperature of about 52 to about 59° C.;
Oven drying (with hot air) at a temperature of about 133° C. to about 205° C.;
Latex dipping;
Oven drying (with hot air) at a temperature of about 139° C. to about 163° C.;
Hot pre-cure leaching at a temperature of about 55° C. to about 73° C.;
Air drying;
Acid priming;
Water rinsing;
Copolymer emulsion coating dipping;
Curing at 100° C. to 160° C.;
Post-cure leaching at 51° C. to 75° C. and rinse;
Slurry dipping with calcium carbonate or silicone (0.2 to 0.8%);
Final drying at about 108° C. to 118° C.;
Glove stripping (removing the glove from the mold);
Dry turning;
Chlorination (e.g., about 100 ppm chlorine strength);
Lubrication using a suitable lubricant, such as silicone ammonium salt of alkyl phosphate and cetylpyridium chloride (CPC);
First drying;
Wet turning; and
Final drying.

The foregoing method describes an exemplary embodiment, and one of ordinary skill in the art would appreciate that some steps may be omitted and/or additional and/or alternative steps may be employed in alternative embodiments. By way of example, and without limitation, after cleaning the glove mold with acid and rinsing, the mold also may be dipped into an alkaline bath to neutralize the acid and then rinsed with water. In some embodiments, the glove mold may be brushed to ensure a smooth surface on the glove mold. In addition, quality testing may be performed on a manufactured glove to detect potential defects, such as air testing (in which the glove is inflated with air) and/or water testing (in which the glove is filled with water).

The amount of the coating applied to a substrate, such as a glove, may be varied depending upon the characteristics of the substrate, the characteristics desired to be imparted to the substrate, and the particular coating employed. In some embodiments, it may be desired to apply the least amount of coating necessary to obtain the desired result. In some embodiments, the applied coating weights may, depending on the coating and the intended use, range from about 0.1 to about 100 g/m². For some pressure sensitive embodiments, the amount may be in the range of about 15 g/m² to about 45 g/m² in some embodiments. Other amounts of coating may be appropriate depending upon the particular process and desired characteristics of the article being manufactured.

As set forth in the following table, additional data was collected for certain samples as applied during a glove manufacturing process. As with the previous data, this data also shows that emulsions as disclosed herein generally provide improved characteristics as compared with water-based coatings. These emulsion coatings also provide environmental advantages over solvent-based coatings.

TABLE 28

| | | | | | Gloves Coating | | COF (Dry) | | | |
|---|---|---|---|---|---|---|---|---|---|---|
| | | | | | Condition | Gloves Coating | Chlo/Lub on | | Chlo/Lub on | |
| | Polymer | Monomer | Cymel 373 | Carbodilite | Formed | Condition | donning side | | patient side | |
| Sample | Base | Components | (%) | (%) | level | Chlorinated level | Static | Kinetic | Static | Kinetic |
| Sample | Emulsion | 75 HEMA | 2 | — | Not tacky, | Coating not flake | 0.22 | 0.11 | 0.32 | 0.18 |
| 19 | | 11 EHA | | | easy to strip | off | | | | |
| (Plate | | 11 MMA | 5 | — | Not tacky, | Coating not flake | 0.17 | 0.06 | 0.20 | 0.09 |
| Dipping) | | 3 MAA | | | easy to strip | off | | | | |
| (without | | | 8 | — | Not tacky, | Minor coating | 0.13 | 0.06 | 0.17 | 0.04 |
| acid | | | | | easy to strip, | flake off | | | | |
| priming) | | | — | 2 | Not tacky, | Tacky. Coating not | 0.64 | 0.29 | 0.52 | 0.13 |
| | | | | | easy to strip | flake off | | | | |
| | | | — | 5 | Not tacky, | Tacky. Coating not | 1.13 | 0.61 | 0.91 | 0.37 |
| | | | | | easy to strip | flake off | | | | |
| | | | — | 8 | Not tacky, | Tacky. Coating not | 0.73 | 0.28 | 1.15 | 0.44 |
| | | | | | easy to strip | flake off | | | | |
| Sample | Emulsion | 75 HEMA | 5 | — | Not tacky, | Coating flake off | 0.33 | 0.16 | 0.17 | 0.16 |
| 19 | | 11 EHA | (w/o acid) | | easy to strip | | | | | |
| (Mold | | 11 MMA | 5 | — | Not tacky, | Coating flake off | 0.23 | 0.08 | 0.04 | 0.05 |
| Dipping) | | 3 MAA | (with acid) | | easy to strip | | | | | |
| Sample 5 | Water | 97 HEMA | 2 | — | Tacky | Not able to proceed with chlorination | | | | |
| (Mold | | 3 MA | 5 | — | Not tacky, | Coating not flake | 0.83 | 0.37 | Badly tacky | |
| Dipping) | | | | | difficult to strip | off | | | after | |
| | | | | | | | | | chlorination | |
| Sample | Emulsion | 75 HEMA | 2 | — | Tacky | Not able to proceed with chlorination | | | | |
| 17 | | 22 LM | 5 | — | Not tacky, | Coating not flake | 0.29 | 0.20 | 0.32 | 0.32 |
| (Molding | | 3 MAA | | | difficult to strip | off | | | | |
| Dipping) | | | 8 | — | Not tacky, | Coating not flake | 0.31 | 0.22 | 0.12 | 0.08 |
| | | | (w/o acid) | | OK to strip | off | | | | |
| | | | 8 | — | Not tacky, | Coating not flake | — | — | 0.11 | 0.12 |
| | | | (with acid) | | OK to strip | off | | | | |

Physical properties were also obtained for Sample 19 as applied to a film using mold dipping and using 5% Cymel 373 (which is a water-soluble melamine-formaldehyde resin crosslinker that is available from Cytec Industries of Woodland Park, N.J.), as shown below in Tables 29 and 30.

TABLE 29

| | Chlo/Lub on Donning Side | | Chlo/Lub on Patient Side | |
|---|---|---|---|---|
| Process | Without Acid | With Acid | Without Acid | With Acid |

Unaged

| | | | | |
|---|---|---|---|---|
| Tensile Strength | 283 | 250 | 252 | 280 |
| (kg/cm²) | | | | |
| Modulus 300% | 17 | 14 | 15 | 16 |
| (kg/cm²) | | | | |
| Modulus 500% | 47 | 31 | 31 | 36 |
| (kg/cm²) | | | | |
| U. Elongation (%) | 845 | 924 | 806 | 845 |

Aged 70 C. @7 days

| | | | | |
|---|---|---|---|---|
| Tensile Strength | 227 | 131 | 275 | 212 |
| (kg/cm²) | | | | |
| Modulus 300% | 10 | 7 | 12 | 8 |
| (kg/cm²) | | | | |
| Modulus 500% | 18 | 13 | 24 | 17 |
| (kg/cm²) | | | | |
| U. Elongation (%) | 1022 | 1002 | 924 | 1042 |

TABLE 30
Sample 19

| | | Reduced |
|---|---|---|
| | Hardness | Modulus |
| Crosslinker | (GPa) | (GPa) |
| Polycup-2% | 0.099 | 2.712 |
| Carbodilite E02-2% | 0.077 | 2.097 |
| Carbodilite E02-5% | 0.064 | 1.932 |
| Carbodilite E02-8% | 0.081 | 2.954 |
| Cymel 373-2% | 0.074 | 2.133 |
| Cymel 373-5% | 0.080 | 2.349 |
| Cymel 373-8% | 0.075 | 2.199 |

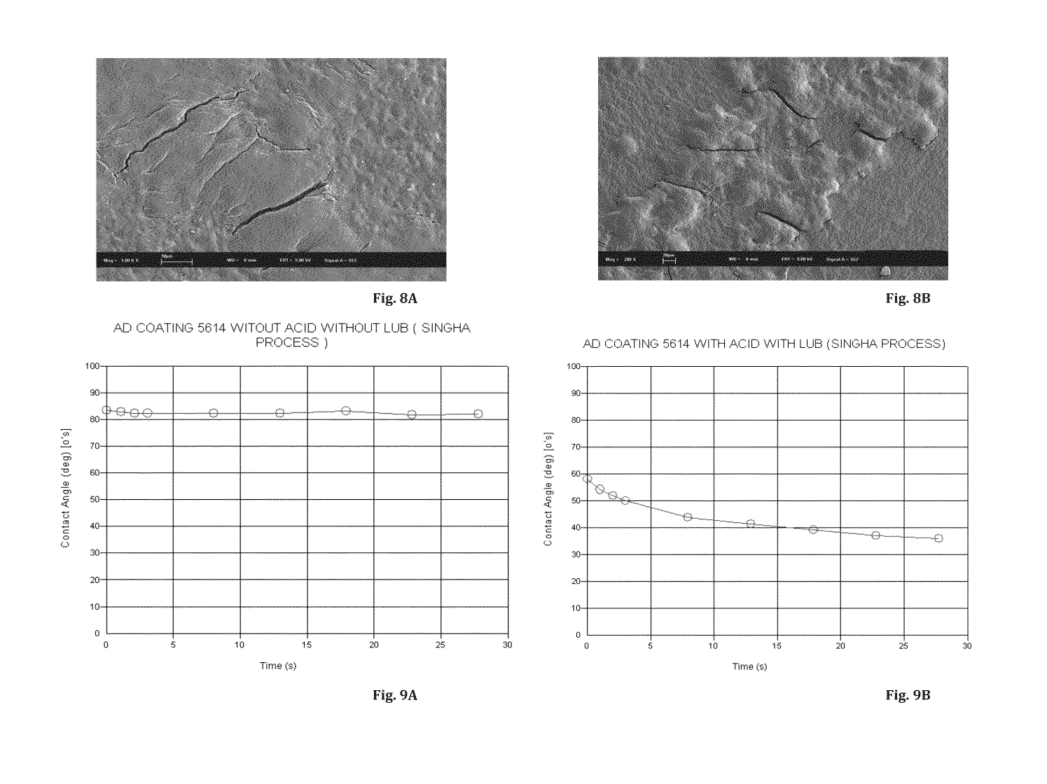

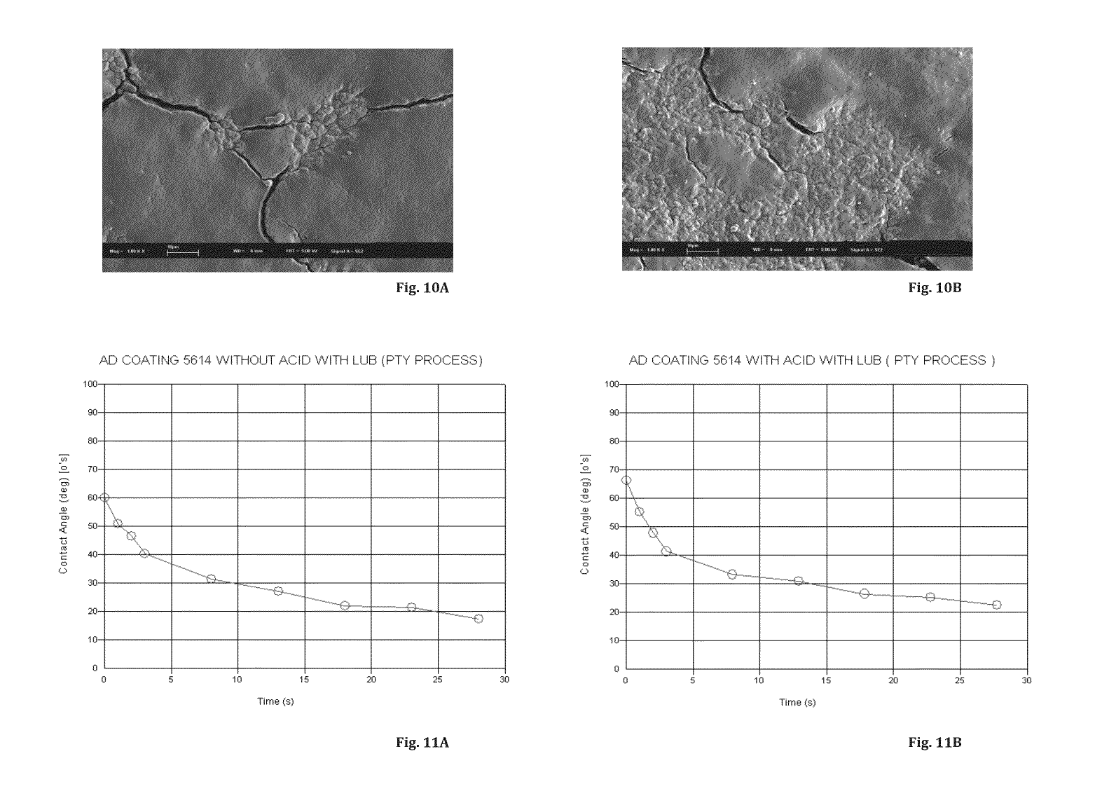

Scanning electron microscope images and contact angle data were also obtained for Sample 19 (emulsion) applied to a glove on the donning side only by using mold dipping with 5% Cymel 373 as a crosslinker. In particular, FIG. 8A shows an image of the patient side of a glove without lubrication, without acid priming, and with low chlorine applied during chlorination, and FIG. 9A provides a graph of contact angle data glove. FIG. 8B provides an image of a glove with the same parameters except using acid priming, and FIG. 9B shows provides contact angle data for the glove of FIG. 8B. FIGS. 10A and 11A provide an image and contact angle data, respectively, of the donning side of the glove of FIGS. 8A and 9A after turning the glove but with high chorine applied to the donning side during chlorination. Similarly, FIGS. 10B and 11B provide, respectively an image and contact angle data, respectively, for the donning side of the glove of FIGS. 8B and 9B after turning the glove and applying high chorine to the donning side.

The foregoing contact angle data was collected by casting the film on a hard, nonporous surface and then placing a drop of water on the cast film. The water droplet's contact angle was then measured, which is the interior arc from the surface of the film to exterior surface of the droplet. Generally, a lower contact angle represents a greater wet-ability of the film.

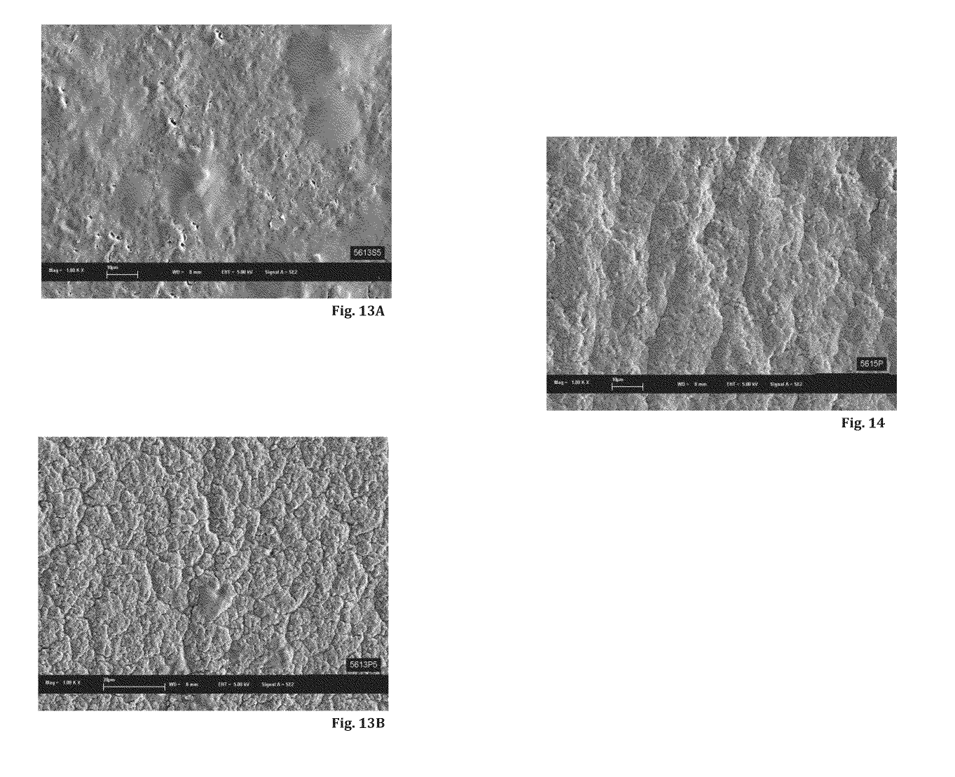

Scanning electron microscope images for Sample 17 (emulsion) applied to a glove using 8% Cymel 373 and a mold dipping process are shown in FIGS. 12A (showing the patient side using low chlorine, no lubrication, no glove turning, and without acid priming) and 12B (showing the patient side using low chlorine, no lubrication, without glove turning, and with acid priming), and FIG. 12C (showing the donning side using high chlorine, no lubrication, without glove turning, and without acid priming). Furthermore, images for Sample 17 applied to a glove using 5% Cymel 373 and a mold dipping process are shown in FIG. 13A (showing the patient side using low chlorine, no lubrication, no glove turning, and without acid priming) and FIG. 13B (showing the donning side using high chlorine, no lubrication, with glove turning, and without acid priming). Finally, images for Sample 5 (water-based) applied to a glove using 5% Cymel 373 and a mold dipping process are shown in FIG. 14 (showing the patient side using low chlorine, no lubrication, no glove turning, and without acid priming). These figures again show comparable, if not improved, performance of the emulsions disclosed herein, which provide a generally smooth application with minimal cracking, as compared with water-based coatings.

In some applications of coatings to articles, undesirable flaking of the coating may occur. In some embodiments, flaking may be decreased by including a “softer” monomer in the monomer feed and/or the pre-emulsion feed, wherein the softer monomer has a relatively lower glass transition temperature (“Tg”) than at least one other monomer present in the feed. For instance, a monomer feed may include one or more monomers having a relatively higher glass transition temperature (“Tg”) and one or more other monomers having a relatively lower Tg. By way of example, a monomer feed in some embodiments may comprise 2-hydroxyethyl methacrylate, which has a Tg in the range of about 50° C. to about 80° C., and the “softer” 4-hydroxybutyl acrylate, which has a Tg of about −30°. The inclusion of the “softer” monomer, such as 4-hydroxybutyl acrylate, may help reduce flaking in some coatings. In addition or alternatively, a pre-emulsion feed may include a monomer having a lower Tg than one or more other monomers in an effort to “soften” the coating and potentially reducing flaking. For instance, a pre-emulsion feed may include one or more monomers having a relatively higher glass transition temperature (“Tg”) and one or more other monomers having a relatively lower Tg. By way of example, a pre-emulsion feed in some embodiments may comprise 2-ethylhexyl acrylate, which has a Tg in the range of about −50° C. The inclusion of a “softer” monomer, such as 2-ethylhexyl acrylate, may help reduce flaking in some coatings. By way of further example, a pre-emulsion feed may include methyl methacrylate, which has a Tg in the range of about 100° C., and the “softer” monomer of 2-ethylhexylacrylate, which has a Tg in the range of about −50° C. to about −70° C. The ratios of such monomers can be adjusted to obtain a desired characteristic in a coating.

Additional testing, including flaking observation, was performed on latex films coated with Sample 19. The comparative testing was done using the aforementioned control, which is a solvent-based coating known to have suitable characteristics for glove coating applications. The additional testing was performed using the following procedures:
1. The Sample 19 emulsion-based copolymer was diluted with deonized (“DI”) water to 3.5-4.0% of the total solids content (“TSC”).
2. 3.5-4.0% of the crosslinker Cymel 373 was added to the Sample 19 emulsion based on dry weight of the crosslinker to the dry weight of the copolymer.
3. The polymer solution was brought to a temperature of about 34° C.
4. The polymer solution was coated on a latex film, the latex film being heated up to a temperature of about 40-45° C. prior to the coating process and after leaching.
5. After coating, the mold upon which the film was applied was rotated in the oven to ensure even coating on the film.
6. The coated film was then cured at 140° C. for 30 minutes.
7. The coated film was then chlorinated on the donning and/or patient side to remove any powder with a chlorine strength of about 80 ppm.

Based upon the testing procedures above, the following results were obtained, wherein the degree of coating flaking was evaluated on a scale of 1 to 5 with 1 indicating the lowest flake and 5 indicating the highest flake:

TABLE 31

| Sample | Sample 19 | | | | Sample 19 | | | | Sample 19 | | | | Control | | | |
|---|---|---|---|---|---|---|---|---|---|---|---|---|---|---|---|---|
| Coating TSC | 4.0 | | | | 4.0 | | | | 3.5 | | | | 4.0 | | | |
| (%) | | | | | | | | | | | | | | | | |
| Cymel 373 (%) | 4.0 | | | | 3.5 | | | | 3.5 | | | | NA | | | |
| Coefficient of | Donning | | | | | | Donning | | | | Donning | | | | Donning | |
| Friction (COF) | Palm | | Donning Finger | | Donning Palm | | Finger | | Donning Palm | | Finger | | Donning Palm | | Finger | |
| Sample | Static | Kinetic | Static | Kinetic | Static | Kinetic | Static | Kinetic | Static | Kinetic | Static | Kinetic | Static | Kinetic | Static | Kinetic |
| Average | 0.04 | 0.04 | 0.08 | 0.09 | 0.04 | 0.06 | 0.08 | 0.09 | 0.08 | 0.08 | 0.04 | 0.05 | 0.02 | 0.03 | 0.03 | 0.07 |
| Std Dev | 0.01 | 0.01 | 0.07 | 0.09 | 0.01 | 0.01 | 0.00 | 0.01 | 0.08 | 0.07 | 0.04 | 0.04 | 0.01 | 0.02 | 0.00 | 0.01 |

| | | | | |
|---|---|---|---|---|
| Physical | | | | |
| Properties of | | | | |
| Chlorinated | | | | |
| Gloves | | | | |
| (Unaged) | | | | |
| Tensile | 280 | 281 | 273 | 267 |
| Strength | | | | |
| (kg/cm²) | | | | |
| Stress 300% | 17 | 15 | 15 | 17 |
| (kg/cm²) | | | | |
| Stress 500% | 49 | 38 | 37 | 46 |
| (kg/cm²) | | | | |
| Ultimate | 845 | 885 | 845 | 845 |
| Elongation % | | | | |
| Powder | | | | |
| Content | | | | |
| Powder | Not tested | 1.22 | 1.56 | 0.60 |
| Content | | | | |
| (mg/film) | | | | |
| Observations | | | | |
| Coating | Fair | Fair | Good | Excellent |
| Evenness | | | | |
| *Degree of | 4 | 4 | 3 | 1 |
| Coating | | | | |
| Flaking | | | | |

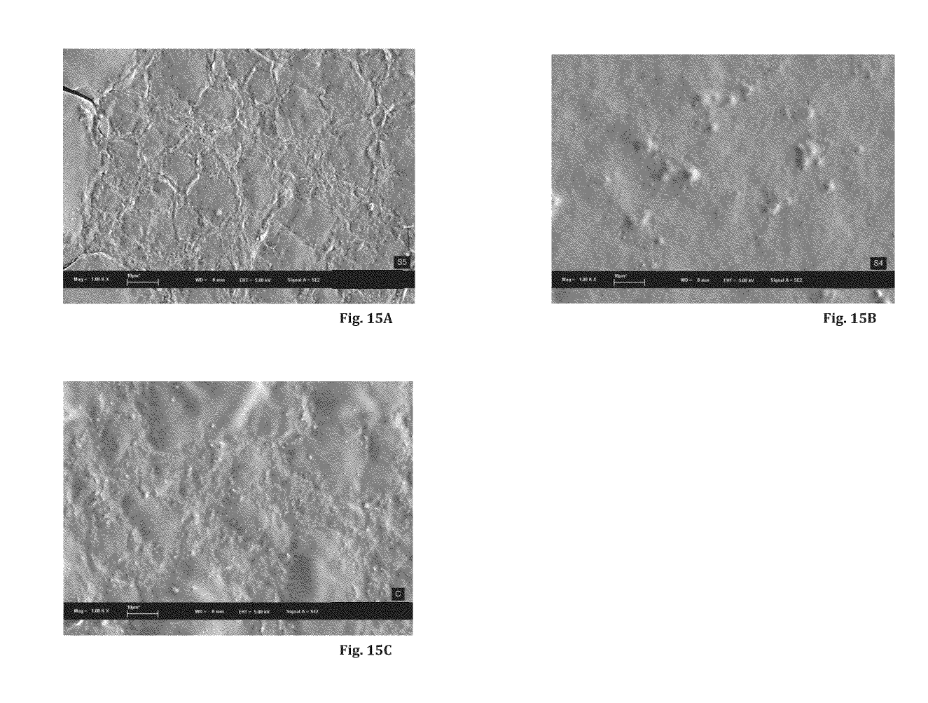

Upon review of the samples tested above, reduced flaking and an improved coating evenness were observed with a coating having a lower total solids content/concentration and decreased Cymel content. In addition, increasing the temperatures of the coating and the film and rotating the mold under a constant temperature were also observed to improve coating evenness and to reduce flaking. FIG. 15A shows a scanning electron microscope image of a film coated with Sample 19 having a total solids content of 3.5% and 3.5% Cymel, and FIG. 15B shows a scanning electron microscope image of a film coated with Sample 19 having a total solids content of 4% and 3.5% Cymel. FIG. 15C shows a scanning electron microscope image of a film coated with the control sample. Each of these images is of the patient side of the film, and the testing employed low chlorination, no lubrication, and no turning process during the coating process.

The following Table shows the results of additional experiments performed on polymeric emulsions containing HEMA/EHA/MMA/MAA (75/11/11/3), for Samples H-J, but using a glove that is pretreated prior to coating with the emulsion. In these examples, the pretreatment comprised an acid priming step comprising either an HCl priming step or an aluminum sulphate priming step where the glove was dipped into the respective solution prior to coating with the polymer emulsion and dried. The additional testing was performed using the following procedures:
1. The Sample 19 emulsion-based copolymer was diluted with deonized (“DI”) water to 3.5-4.0% of the total solids content (“TSC”).
2. About 3.5% of the crosslinker Cymel 373 was added to the Sample 19 emulsion based on dry weight of the crosslinker to the dry weight of the copolymer.
3. The polymer solution was chilled and maintained at about 34° C.
4. Prior to the application of the polymer coating, the latex film, i.e., glove sample, was either dipped in an HCl acid priming solution or in an Aluminium Sulphate solution or none at all, as indicated in the Table below, and dried in the oven at 100° C. to 150° C. for 1 to 2 minutes. Sample H was pretreated with aluminum sulphate, Sample I was pretreated with an HCl priming solution and Sample J was not pretreated.
5. The polymer solution was then coated onto the latex film using a dipping process, the latex film being heated up to a temperature of about 40° C.-45° C. prior to the coating process.
6. After coating, the mold upon which the film was applied was rotated in the oven to ensure even coating on the film.
7. The coated film was then cured at 140° C. for 30 minutes.
8. The coated film was then chlorinated on the donning and/or patient side to remove any powder with a chlorine strength of about 80 ppm.
9. The gloves were then tested as indicated in the table below. The aged samples were aged using a heat accelerated aging process, as specified in ASTM D-412 method, in which the aged gloves were placed in an oven for 7 days at about 70° C. The unaged samples were tested without performing such a heat treatment aging process.

The following test results were obtained, as indicated below in Table 32.

TABLE 32

| Coating Type | H | I | J |
|---|---|---|---|
| Type of | Aluminum Sulphate | HCl | None |
| Pretreatment | | | |
| Concentration of | 3 | 4.5 | N/A |
| Pretreatment (%) | | | |

Physical Properties of Sterile Gloves (Unaged)

| | | | |
|---|---|---|---|
| Tensile Strength | 289 | 250 | 283 |
| (kg/cm²) | | | |
| Stress 300% | 11 | 14 | 17 |
| (kg/cm²) | | | |
| Stress 500% | 25 | 31 | 47 |
| (kg/cm²) | | | |
| Ultimate | 924 | 924 | 845 |
| Elongation % | | | |

Physical Properties of Sterile Gloves (Aged)

| | | | |
|---|---|---|---|
| Tensile Strength | 287 | 131 | 227 |
| (kg/cm²) | | | |
| Stress 300% | 12 | 7 | 10 |
| (kg/cm²) | | | |
| Stress 500% | 29 | 13 | 18 |
| (kg/cm²) | | | |
| Ultimate | 943 | 1002 | 1022 |
| Elongation % | | | |

From the above results in Table 32, both Samples H and I exhibited satisfactory results for unaged gloves, with Sample H (aluminum sulphate pretreated glove) exhibiting slightly better tensile strength results. However, the gloves treated with aluminum sulphate, Sample H, maintained better tensile strength values upon aging than the acid priming treated gloves (Sample I) and than the sample that was not pretreated (Sample J). According to the ASTM D-412 standard, the aged tensile strength requirement for a glove is at least 185 kg/cm². Thus, the aged gloves pretreated with HCl were below this value. The aged glove pretreated with aluminum sulphate (Sample H) generally exhibited better values overall having higher tensile strength values and stress values.

In Table 33 below, additional experiments were performed on Sample 19, with the gloves pretreated prior to coating with the emulsion in an aluminum sulphate priming step. These samples are designated as Samples K-L. The additional testing was performed using the following procedures:
1. The emulsion-based copolymer samples were diluted with deonized (“DI”) water to about 3.5% of the total solids content (“TSC”). Both Samples K and L contain a HEMA/EHA/MMA/MAA concentration of 75/11/11/3, however, the difference between these two samples is how the emulsion-based copolymer coatings were stabilized. Sample K utilized KOH to stabilize the coating, while Sample 0 utilized ammonium hydroxide to stabilize the coating.
2. About 3.5% of the crosslinker Cymel 373 was added to each of Samples K-L based on dry weight of the crosslinker to the dry weight of the copolymer.
3. The polymer solution was chilled and maintained at about 34° C.
4. Prior to the application of the polymer coating, the latex film, i.e., glove sample, was dipped in an Aluminium Sulphate solution, as indicated in the Table below, and dried in the oven at 100° C. to 150° C. for 1 to 2 minutes.
5. The polymer solution was then coated onto the latex film, the latex film being heated up to a temperature of about 40° C.-45° C. prior to the coating process.
6. After coating, the mold upon which the film was applied was rotated in the oven to ensure even coating on the film.
7. The coated film was then cured at 140° C. for 30 minutes.
8. The coated film was then chlorinated on the donning and/or patient side to remove any powder with a chlorine strength of about 80 ppm.

TABLE 33

| Coating | Sample K | Sample L |
|---|---|---|
| HEMA | 75 | 75 |
| EHA | 11 | 11 |
| MMA | 11 | 11 |
| MAA | 3 | 3 |
| Coating TSC (%) | 3.5 | 3.5 |
| Cymel 373 (%) | 3.5 | 3.5 |
| Priming Agent | Aluminium | Aluminium |
| | Sulphate | Sulphate |
| Primer conc (%) | 1.5 | 1.5 |
| Physical Properties of Sterile | | |
| Gloves (Unaged) | | |
| Tensile Strength | 289 | 296 |
| (kg/cm²) | | |
| Stress 300% | 11 | 11 |
| (kg/cm²) | | |
| Stress 500% | 25 | 30 |
| (kg/cm²) | | |
| Ultimate | 924 | 884 |
| Elongation % | | |
| Physical Properties of Sterile | | |
| Gloves (Aged) | | |
| Tensile Strength | 287 | 290 |
| (kg/cm²) | | |
| Stress 300% | 12 | 13 |
| (kg/cm²) | | |
| Stress 500% | 29 | 25 |
| (kg/cm²) | | |
| Ultimate | 943 | 924 |
| Elongation % | | |
| Powder content | 1.82 | 1.90 |
| (mg/glove) | | |

Observations

| | | |
|---|---|---|
| Coating | No | No |
| sedimentation | | |
| Internal tacky | Slightly | Yes |
| during processing | | |
| Dry donning | Fair | Fair |

Overall, both Samples K and L had similar results, both having favorable results for both the aged and unaged gloves, but with fair donnability. The one difference being observed during processing, where Sample K had slight tackiness observed whereas Sample L had a greater amount of tackiness observed.

The composition and process disclosed herein can further include articles that have been coated with a polymeric emulsion of the type described herein and methods for making such articles. In some instances, such articles include natural rubber, synthetic rubber, or latex, such as, without limitation, surgical gloves, physician examining gloves, industrial gloves, prophylactics, catheters, balloons, tubing, sheeting, other elastomeric articles, and similar articles. As indicated above, rubber or latex gloves may require the ability of donning, i.e, the ability to slide a glove on and off the surface of the skin, with minimal friction. As such, a flexible, non-tacky glove coating applied to the interior of a glove may be useful to allow donning, wet or dry, of the glove with minimal blocking and without undue friction or clinging. The foregoing examples indicate the suitability of the emulsions disclosed herein for these purposes.

In addition, as demonstrated by the test results presented herein, certain emulsions disclosed herein provide reduced static and kinetic dry coefficients of friction as compared with water soluble coatings. Such reduced coefficients of friction are desirable in many applications, such as for surgical and examination gloves that require donning capabilities. In addition, the emulsion examples shown herein provide reduced tackiness and/or stickiness, particularly as compared with water-based coatings. Reduced tackiness and stickiness are also desirable features for glove applications. For reference, tackiness may be used to reference the adherence of an article to itself or an identical article, whereas stickiness may be used to reference the adherence of an article to other material. These features offered by embodiments disclosed herein may beneficially alleviate the need for using powder or other lubricating materials with the gloves.

By way of further examples, and without limitation, the emulsion coating prepared in accordance with the methods disclosed herein may be suitable for the preparation of, and use, as elastomeric films, pressure sensitive adhesives, coatings, hydrogels, and compositions for topical applications to the skin such as, creams, lotions, ointments, gels, aerosols, sprays, cosmetic compositions, deodorants, and insect repellants. Such uses may include medical elastomeric films, bandages, tapes, wound care dressings, surgical drapes, ostomy site dressings, as a carrier for transdermal drug delivery systems, and as a carrier for mucus membrane drug delivery systems.

One of ordinary skill in the art will readily appreciate that the emulsion coatings disclosed herein can be applied to articles by any conventional method or process. These application methods may include, for example, dipping, die coating, roll coating, reverse roll coating, gravure coating, reverse gravure coating, offset gravure coating, Mayer rod or wire wound rod coating, spraying, brushing, and the like. The polymers and copolymers disclosed herein may be heated or cooled to facilitate the coating process and to alter the depth or penetration into the substrate.

These and other modifications and variations may be practiced by those of ordinary skill in the art without departing from the spirit and scope of the composition and process disclosed herein, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the disclosure herein as further described in such appended claims. Therefore, the spirit and scope of the appended claims should not be limited to the exemplary description of the versions contained herein.

What is claimed is:

1. A coated article comprising:
a coating composition comprising an emulsion;
wherein the emulsion comprises at least one water-soluble monomer and at least one water-insoluble monomer.

2. The article of claim 1, wherein the water-soluble monomer is selected from the group consisting of 2-hydroxyethyl methacrylate and 4-hydroxybutyl acrylate.

3. The article of claim 1, wherein the water-insoluble monomer is selected from the group consisting of methyl acrylate, ethyl acrylate, butyl acrylate, propyl acrylate, 2-ethylhexyl acrylate, butyl methacrylate, methyl methacrylate, lauryl methacrylate, stearyl methacrylate, 2-ethylhexyl methacrylate, trifluoro ethyl methacrylate, isooctyl acrylate, isodecyl acrylate, and dimethylamino ethyl methacrylate.

4. The article of claim 1, wherein the article comprises a glove.

5. The article of claim 1, wherein the emulsion further comprises one or more of the following additional components selected from the group consisting of surfactant, stabilizer, and crosslinker.

6. The article of claim 5, wherein the surfactant comprises sodium lauryl ether sulfate.

7. The article of claim 5, wherein the stabilizer comprises polyvinyl alcohol.

8. The article of claim 5, wherein the crosslinker is selected from the group consisting of formaldehydes, melamine formaldehydes, metal salts, aziridines, isocyanates, dichromates, polyfunctional aziridine, titanium acetylacetonates, polyamide-epichlorohydrin-type resin, and carbodiimide compounds.

9. The article of claim 5, wherein the crosslinker comprises melamine formaldehyde.

10. The article of claim 1, wherein the emulsion comprises 2-hydroxylethyl methacrylate, 2-ethylhexylacrylate, and methacrylic acid.

11. The article of claim 1, wherein the emulsion comprises 2-hydroxylethyl methacrylate, 2-ethylhexyl methacrylate, and methacrylic acid.

12. The article of claim 1, wherein the emulsion comprises 2-hydroxylethyl methacrylate, lauryl methacrylate, and methacrylic acid.

13. The article of claim 1, wherein the emulsion comprises 2-hydroxylethyl methacrylate, lauryl methacrylate, methacrylic acid, and silica.

14. The article of claim 1, wherein the emulsion comprises 2-hydroxylethyl methacrylate, 2-ethylhexylacrylate, methyl methacrylate, and methacrylic acid.

15. A method of making a coated rubber glove, comprising:
applying a coating material to a rubber glove formed upon a glove mold to result in an emulsion coated glove, the coating material comprising an emulsion having at least one water-soluble monomer and at least one water-insoluble monomer;
curing the emulsion coated glove on the glove mold at a temperature of between about 100° C. to 160° C.;
subjecting the emulsion coated glove to a leaching solution;
optionally dipping the emulsion coated glove in a slurry composition;
drying the emulsion coated glove; and
removing the coated glove from the glove mold to result in the coated rubber glove.

16. The method of claim 15, wherein the water-soluble monomer is selected from the group consisting of 2-hydroxyethyl methacrylate and 4-hydroxybutyl acrylate.

17. The method of claim 15, wherein the water-insoluble monomer is selected from the group consisting of methyl acrylate, ethyl acrylate, butyl acrylate, propyl acrylate, 2-ethylhexyl acrylate, butyl methacrylate, methyl methacrylate, lauryl methacrylate, stearyl methacrylate, 2-ethylhexyl methacrylate, trifluoro ethyl methacrylate, isooctyl acrylate, isodecyl acrylate, and dimethylamino ethyl methacrylate.

18. The method of claim 15, wherein the emulsion further comprises one or more of the following additional components selected from the group consisting of surfactant, stabilizer, and crosslinker.

19. The method of claim 18, wherein the surfactant comprises sodium lauryl ether sulfate.

20. The method of claim 18, wherein the stabilizer comprises polyvinyl alcohol.

21. The method of claim 18, wherein the crosslinker is selected from the group consisting of formaldehydes, melamine formaldehydes, metal salts, aziridines, isocyanates, dichromates, polyfunctional aziridine, titanium acetylacetonates, polyamide-epichlorohydrin-type resin, and carbodiimide compounds.

22. The method of claim 15, wherein the emulsion comprises 2-hydroxylethyl methacrylate, 2-ethylhexylacrylate, and methacrylic acid.

23. The method of claim 15, wherein the emulsion comprises 2-hydroxylethyl methacrylate, 2-ethylhexyl methacrylate, and methacrylic acid.

24. The method of claim 15, wherein the emulsion comprises 2-hydroxylethyl methacrylate, lauryl methacrylate, and methacrylic acid.

25. The method of claim 15, wherein the emulsion comprises 2-hydroxylethyl methacrylate, lauryl methacrylate, methacrylic acid, and silica.

26. The method of claim 15, wherein the emulsion comprises 2-hydroxylethyl methacrylate, 2-ethylhexylacrylate, methyl methacrylate, and methacrylic acid.

27. The method of claim 15, wherein the curing of the emulsion coated glove occurs at a temperature between about 135° C. to about 145° C.

28. The method of claim 15, wherein the curing of the emulsion coated glove occurs for a time period of between about 20 to about 40 minutes.

29. A coating composition comprising:
at least one water-soluble monomer;
at least one water-insoluble monomer; and
one or more additional components selected from the group consisting of surfactant, stabilizer, and crosslinker.

30. The coating composition of claim 29, wherein the water-soluble monomer is selected from the group consisting of 2-hydroxyethyl methacrylate and 4-hydroxybutyl acrylate.

31. The coating composition of claim 29, wherein the water-insoluble monomer is selected from the group consisting of methyl acrylate, ethyl acrylate, butyl acrylate, propyl acrylate, 2-ethylhexyl acrylate, butyl methacrylate, methyl methacrylate, lauryl methacrylate, stearyl methacrylate, 2-ethylhexyl methacrylate, trifluoroethyl methacrylate, isooctyl acrylate, isodecyl acrylate, and dimethylaminoethyl methacrylate.

32. The coating composition of claim 29, wherein the surfactant comprises sodium lauryl ether sulfate.

33. The coating composition of claim 29, wherein the stabilizer comprises polyvinyl alcohol.

34. The coating composition of claim 29, wherein the crosslinker is selected from the group consisting of formaldehydes, melamine formaldehydes, metal salts, aziridines, isocyanates, dichromates, polyfunctional aziridine, titanium acetylacetonates, polyamide-epichlorohydrin-type resin, and carbodiimide compounds.

35. The coating composition of claim 34, wherein the crosslinker comprises melamine formaldehyde.

36. The coating composition of claim 29, wherein the coating composition comprises 2-hydroxylethyl methacrylate, 2-ethylhexylacrylate, and methacrylic acid.

37. The coating composition of claim 29, wherein the coating composition comprises 2-hydroxylethyl methacrylate, 2-ethylhexyl methacrylate, and methacrylic acid.

38. The coating composition of claim 29, wherein the coating composition comprises 2-hydroxylethyl methacrylate, lauryl methacrylate, and methacrylic acid.

39. The coating composition of claim 29, wherein the coating composition comprises 2-hydroxylethyl methacrylate, lauryl methacrylate, methacrylic acid, and silica.

40. The method of claim 15, wherein the slurry composition comprises silicone.

41. The method of claim 15, wherein the emulsion coated glove is subjected to a chlorination process.

42. The method of claim 15, wherein the emulsion coated glove is lubricated.

43. The method of claim 15, further comprising the step of pretreating the rubber glove formed on the mold with a priming solution prior to applying the coating material.

44. The method of claim 15, wherein the priming solution comprises one of the compounds selected from the group consisting of sulfuric acid, hydrochloric acid and aluminum sulphate.

45. A method of making a coated latex glove, comprising:
forming a latex film on a glove mold;
dipping the latex film on the mold into a priming solution;
drying the latex film in an oven at a temperature between about 100° C. to about 150° C. for about 1 to about 2 minutes;
preparing a coating composition comprising a copolymer emulsion having at least one water-soluble monomer and at least one water-insoluble monomer;
applying the coating composition to the latex film on the mold to result in an emulsion coated glove;
curing the emulsion coated glove at a temperature of between about 100° C. to about 160° C.; and
removing the emulsion coated glove from the glove mold to result in the coated latex glove.

46. The method of claim 45, wherein preparing the coating composition further comprises adding a crosslinker.

47. The method of claim 46, wherein the crosslinker is selected from the group consisting of formaldehydes, melamine formaldehydes, metal salts, aziridines, isocyanates, and dichromates.

48. The method of claim 45, wherein the priming solution comprises a solution having a component selected from the group consisting of a sulfuric acid, hydrochloric acid, and aluminum sulphate.

49. The method of claim 48, wherein the priming solution comprises aluminum sulphate.

50. The method of claim 45, wherein the copolymer emulsion is diluted with water to a total solids content of about 3.5% to about 4%.

51. The method of claim 45, further comprising maintaining the coating composition at a temperature range of about 15° C. to about 75° C. during application of the coating composition to the latex film.

52. The method of claim 45, wherein curing the emulsion further comprises curing for a time of about 30 minutes.

53. The method of claim 49, wherein the aluminum sulphate is in an amount of up to about 10% by weight.

54. The method of claim 45, wherein the water-soluble monomer comprises from about 50% to about 97% of the total monomer weight.

55. The method of claim 45, wherein the water insoluble monomer comprises at least 15% of the total monomer weight.

56. The method of claim 45, further comprising the step of chlorinating the emulsion coated glove to remove any powder.

57. The method of claim 56, wherein the chlorinating step is carried out at a chlorine strength of about 80 ppm.

58. The method of claim 45, wherein the step of applying the coating composition comprises dipping the latex film into the coating composition.

59. The method of claim 45, wherein the water-soluble monomer is selected from the group consisting of 2-hydroxyethyl methacrylate and 4-hydroxybutyl acrylate.

60. The method of claim 45, wherein the water insoluble monomer is selected from the group consisting of methyl acrylate, ethyl acrylate, butyl acrylate, propyl acrylate, 2-ethylhexyl acrylate, methyl methacrylate, lauryl methacrylate, 2-ethylhexyl methacrylate, trifluoroethyl methacrylate, isooctyl acrylate, isodecyl acrylate, and dimethylaminoethyl methacrylate.
